(19) United States
(12) Patent Application Publication
(10) Pub. No.: US 2026/0217548 A1
(43) Pub. Date: Jul. 30, 2026

(54) METHOD FOR THE TREATMENT OF LITHIUM BEARING MATERIAL

(71) Applicant: Primero Group Limited, Western Australia (AU)

(72) Inventors: Damien A. Krebs, Western Australia (AU); Kong S. Teav, Western Australia (AU)

(21) Appl. No.: 19/140,216

(22) PCT Filed: Nov. 26, 2024
(86) PCT No.: PCT/AU2024/051260

§ 371 Date: Jun. 17, 2025

(30) Foreign Application Priority Data
Nov. 27, 2023 (AU) 2023903818

(51) Int. Cl. C01D 15/08; C01D 15/02; C22B 1/02; C22B 1/24; C22B 3/12; C22B 3/22; C22B 26/12

(52) U.S. Cl. CPC C01D 15/08; C01D 15/02; C22B 1/02; C22B 1/2406; C22B 3/12; C22B 3/22; C22B 26/12

(57) ABSTRACT

A method for the extraction of lithium, the method comprising the steps of: Subjecting a lithium bearing material to a leaching process at atmospheric pressure and at an elevated temperature of greater than 50° C. but less than 160° C. in the presence of carbonate ions to produce a leaching slurry containing lithium carbonate; Performing a carbonation process on the leaching slurry to convert at least a portion of the lithium carbonate to lithium bicarbonate; Performing a solid-liquid separation process on the leaching slurry to separate a leach residue from a leaching solution; Obtaining solid lithium carbonate from the leaching solution; and Separating the solid lithium carbonate from the leaching solution.

### TECHNICAL FIELD

The present invention relates to a method for the extraction of lithium. In particular, the present invention relates to an atmospheric leaching method for the extraction of lithium from lithium ores or concentrates, such as spodumene ores and concentrates.

### BACKGROUND

Lithium and materials containing lithium have a number of industrial applications, such as in heat-resistant glass and ceramics, lithium grease lubricants, flux additives for iron, steel and aluminium production, lithium metal batteries and lithium-ion batteries.

A large proportion of the lithium mined globally is in the form of spodumene, a mineral comprising lithium aluminium silicate. In many conventional extraction processes, spodumene ores are subjected to a leaching process using extraction reagents such as alkali metal sulphates, sulphuric acid, or hydrofluoric acid.

As depicted by the widely cited U.S. Pat. No. 2,516,109, acid leaching of lithium from spodumene is a conventional extraction process typically characterized by harsh conditions and complex equipment set-ups. It is not unusual for these processes to use concentrated sulphuric acid heated to 250° C. in a sulphating kiln. As such, the conventional extraction processes suffer from the drawbacks that the extraction reagents used present significant environmental and health hazards. Further, conventional extraction processes exhibit high levels of impurities such as iron, magnesium, or aluminium, and generate large quantities of waste products such as sodium sulphate and lime contaminated tailings.

In addition, other methods (such as pressure carbonate leaching and acid baking) require the use of complex equipment, which represents a significant capital cost, as well as being both difficult and costly to maintain.

Some attempts have been made to overcome these problems. For instance, U.S. Pat. No. 11,292,725 discloses a process for extracting lithium from lithium-bearing materials at elevated pressure in the form of lithium carbonate. However, this process requires a purified lithium bearing brine stream from natural lakes or from elevated temperature leaching of beta spodumene. The application of elevated temperature leaching with sodium carbonate produces a solid tailings stream which has limited or no commercial use and requires long term environmental management.

Alternatively, the Quebec process attempts to overcome the aforementioned drawbacks using basic sodium carbonate in a pressure leaching process. While this may reduce the reliance of hazardous reagents initially, the method requires high temperatures and high pressures in specially equipped vessels

Other methods for the treatment of lithium have been described. For instance, U.S. Pat. No. 4,588,566 discloses a method relating to the separation of lithium from lithium-containing materials. However, this document discloses a pretreatment process only that is used in relation to a feed material of lithium bearing clays. This process is not suitable for the extraction of lithium from hard rock lithium minerals.

Chinese Patent Application No. 111593200 discloses a process for recycling lithium cathodes from lithium-ion batteries, and is not suitable for the extraction of lithium from hard rock lithium materials.

International Patent Application No. 2023/097356 discloses a pyrometallurgical treatment process for the “carbonation” of beta spodumene to produce lithium carbonate powder. However, this process requires high temperatures, typically in the range of 400° C. to 600° C., within a reactor to mix carbon dioxide gas with the beta spodumene. These elevated temperatures significantly increase both operational costs and equipment requirements.

European Patent No. 3981516 discloses the use of CO₂ gas for dissolution of lithium from a primary leach feed material (roasted lithium-ion battery material) with a subsequent crystallisation process to recover the lithium carbonate product. However, this process is not suitable for the extraction of lithium from hard rock lithium minerals.

European Patent 4140952 discloses a method of obtaining lithium hydroxide from lithium sulphate in a form of a liquid or solid. This process is designed to process waste lithium ion batteries or various electronic devices, and is not suitable for the extraction of lithium from hard rock lithium minerals. Further, this document discloses a step of “dissolving” lithium in a medium such as water. Thus, this document does not disclose a leaching process.

Thus, there would be an advantage if it were possible to provide a method for the extraction of lithium that was capable of producing a relatively high-grade lithium product, while reducing the use of expensive and harsh conditions, and limiting the production of hazardous waste products.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method for the extraction of lithium, which may at least partially overcome at least one of the abovementioned disadvantages or provide the consumer with a useful or commercial choice.

In a first aspect, the invention resides broadly in a method when used for the extraction of lithium from a hard rock lithium mineral, the method comprising subjecting the lithium bearing material to a leaching process at atmospheric pressure, and at a temperature of greater than 50° C. but less than 160° C., in the presence of carbonate ions to produce a leaching slurry containing lithium carbonate.

As previously stated, the leaching of the lithium bearing material is performed at a temperature of greater than 50° C. but less than 160° C. More preferably, the leaching of the lithium bearing material may be performed at a temperature of greater than 50° C. but less than 140° C. More preferably, the leaching of the lithium bearing material may be performed at a temperature of greater than 50° C. but less than 120° C. Most preferably, the leaching of the lithium bearing material may be performed at a temperature of greater than 50° C. but less than 100° C.

Advantageously, performing the leaching process at temperatures below 160° C. reduces or eliminates the need for specialised high-temperature equipment, thereby reducing the capital and operational costs associated with the present invention. In particular, maintaining the temperature below 160° C. (and especially below 100° C.) reduces or eliminates the need for autoclaves or similar equipment, which would otherwise increase the cost and complexity of the process. Autoclaves require precise pressure control and high-energy input, along with rigorous safety protocols, all of which increase both the initial and ongoing costs of the process. By circumventing these requirements, the process can operate with more accessible and cost-effective equipment, making it scalable and easier to maintain.

Alternatively, the leaching of the lithium bearing material is performed at a temperature of between 50° C. and approximately the boiling point of the leaching solution.

As stated above, lithium is extracted from a hard rock lithium mineral. The hard rock lithium mineral may be of any suitable type, although it is envisaged that the hard rock lithium mineral may comprise spodumene, lepidolite, eucryptite, petalite, a silicate material containing lithium, and the like, or any suitable combination thereof.

In a second aspect, the invention resides broadly in a method for the extraction of lithium, the method comprising the steps of:
Subjecting a lithium bearing material to a leaching process at atmospheric pressure and at a temperature of greater than 50° C. but less than 160° C., in the presence of carbonate ions to produce a leaching slurry containing lithium carbonate;
Performing a carbonation process on the leaching slurry to convert at least a portion of the lithium carbonate to lithium bicarbonate;
Performing a solid-liquid separation process on the leaching slurry to separate a leach residue from the leaching solution;
Obtaining solid lithium carbonate from the leaching solution; and
Separating the solid lithium carbonate from the leaching solution.

The lithium bearing material may be of any suitable form. Preferably, however, the lithium bearing material comprises a lithium mineral. In particular, the lithium mineral may comprise a hard rock lithium mineral. Specifically, the lithium mineral may comprise one or more of spodumene, lepidolite, eucryptite and petalite. The lithium bearing material may comprise an ore, a concentrate, a residue or waste product or the like, or any suitable combination thereof that comprises a hard rock lithium mineral. Preferably, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally occurring materials (such as lithium ores and mineral concentrates), while beta spodumene is more likely to be present in materials such as thermally processed concentrates and the like.

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal processing step.

Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment of the invention, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of lithium minerals present in the lithium bearing material, the particle size of the lithium bearing material, the minerals present in the lithium bearing material and so on.

The thermal processing step may be performed as a batch process or as a continuous process. In a preferred embodiment of the invention the lithium bearing material may be cooled following the thermal processing step, and prior to further processing of the lithium bearing material.

In some embodiments of the invention, the lithium bearing material that has undergone the thermal processing step may be subject to one or more comminution processes and/or one or more classification process prior to the leaching process. In a preferred embodiment of the invention, relatively fine particles of the lithium bearing material may be introduced to the leaching process.

It is envisaged that a significant proportion of the alpha spodumene present in the lithium bearing material may be converted to beta spodumene in the thermal processing step. In some embodiments of the invention, at least 70% of the alpha spodumene present in the lithium bearing material may be converted to beta spodumene in the thermal processing step. More preferably, at least 80% of the alpha spodumene present in the lithium bearing material may be converted to beta spodumene in the thermal processing step. More preferably, at least 90% of the alpha spodumene present in the lithium bearing material may be converted to beta spodumene in the thermal processing step. In some embodiments of the invention, it is envisaged that between about 93% and about 96% of the alpha spodumene present in the lithium bearing material may be converted to beta spodumene in the thermal processing step. Thus, in this embodiment of the invention, a significant proportion of the lithium present in the lithium bearing material that is subjected to the leaching process is in the form of beta spodumene.

As previously stated, the leaching of the lithium bearing material is performed at atmospheric pressure. It will be understood that the term “atmospheric pressure” refers to a pressure that is approximately equal to atmospheric pressure, or less than about 101.325 kPa at sea level. It will be understood, however, that relatively small variations to this pressure are intended to be encompassed within the meaning of the term “atmospheric pressure” that such the term atmospheric pressure may include leaching conducted under a slightly pressurised atmosphere, or under a slight vacuum. For instance, the vessel in which the leaching of the lithium bearing material is performed may be capable of operating at pressures above or below atmospheric pressure.

The leaching process may be conducted in any suitable vessel. Preferably, however, the vessel comprises a tank, reactor, or the like. In a particular embodiment of the invention, the vessel may comprise a reactor, such as a tank or batch reactor. In some embodiments of the invention, the reactor may be agitated. In a specific embodiment, the reactor may be continuously stirred.

As previously stated, the leaching process is performed at an elevated temperature of greater than 50° C. but less than 160° C. More preferably, the leaching of the lithium bearing material is performed at a temperature of greater than 50° C. but less than 140° C. More preferably, the leaching of the lithium bearing material is performed at a temperature of greater than 50° C. but less than 120° C. Most preferably, the leaching of the lithium bearing material is performed at a temperature of greater than 50° C. but less than 100° C.

Preferably, the temperature at which the leaching of the lithium bearing material is performed is configured to be below approximately the boiling point of the leaching solution.

The temperature may be controlled using any suitable method. In some embodiments of the invention, temperature control may be performed using an electrical heating apparatus, direct steam injection (particularly at relatively low pressure), or indirect steam heating. In some embodiments, the temperature of the leaching process may be at least partially controlled via an exchange of heat (and the subsequent recovery of heat) between a relatively cool leach solution recycled from another point in the method and the relatively hot leach slurry leaving the leaching process.

It is envisaged that the lithium bearing material may be introduced to the leaching process in the form of solid material. As previously stated, the lithium bearing material is leached in the presence of carbonate ions. Preferably, the lithium bearing material is introduced to a lixiviant containing carbonate ions and, in particular, an aqueous solution of carbonate ions.

Preferably, the lixiviant comprises carbonate anions and alkali metal cations. Any suitable alkali metal cations may be present, although in a preferred embodiment of the invention, the alkali metal cations may comprise sodium ions and/or potassium ions. It will be understood that the lixiviant may comprise anions other than carbonate. For instance, the lixiviant may comprise bicarbonate ions.

The lixiviant may have any suitable concentration of carbonate ions. For instance, the concentration of carbonate ions in the lixiviant may be between about 6 g/L and 288 g/L. More preferably, the concentration of carbonate ion in the lixiviant may be between about 12 g/L and 230 g/L. Most preferably, the concentration of carbonate ions in the lixiviant may be between about 17 g/L and 173 g/L.

In a particular embodiment of the invention, the carbonate ions may be added as sodium carbonate. For instance, the concentration of sodium carbonate in the lixiviant may be between about 10 g/L and 500 g/L. More preferably, the concentration of sodium carbonate in the lixiviant may be between about 20 g/L and 400 g/L. Most preferably, the concentration of sodium carbonate in the lixiviant may be between about 30 g/L and 300 g/L.

The lixiviant may have any suitable concentration of sodium ions. For instance, the concentration of sodium ions in the lixiviant may be between about 4 g/L and 217 g/L. More preferably, the concentration of sodium ion in the lixiviant may be between about 9 g/L and 174 g/L. Most preferably, the concentration of sodium ions in the lixiviant may be between about 13 g/L and 130 g/L.

In a particular embodiment of the invention, the carbonate ions may be added as potassium carbonate. For instance, the concentration of potassium carbonate in the lixiviant may be between about 10 g/L and 1000 g/L. More preferably, the concentration of potassium carbonate in the lixiviant may be between about 30 g/L and 600 g/L. Most preferably, the concentration of potassium carbonate in the lixiviant may be between about 50 g/L and 300 g/L.

The lixiviant may have any suitable concentration of potassium ions. For instance, the concentration of potassium ions in the lixiviant may be between about 6 g/L and 566 g/L. More preferably, the concentration of potassium ion in the lixiviant may be between about 17 g/L and 339 g/L. Most preferably, the concentration of potassium ions in the lixiviant may be between about 28 g/L and 170 g/L.

In a particular embodiment of the invention, the leaching of lithium bearing material (in the form of beta spodumene) may result in the formation of one or more zeolite minerals. The one or more zeolite minerals may be of any suitable chemical formula, although in one embodiment of the invention, the zeolite mineral may have the formula Na₂Al₂Si₆O₁₆·7H₂O. In this embodiment, the zeolite material may be formed according to the following reaction:

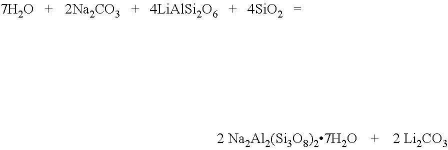

A similar reaction may occur for the leaching of the lithium bearing material in the presence of potassium carbonate.

In this embodiment of the invention, it is envisaged that the leaching reaction may result in the extraction of lithium from the beta spodumene through the exchange of lithium and sodium ions. The sodium aluminium silicate present in the leaching slurry may be in the form of a solid, while the lithium carbonate generated by the leaching reaction may be present in the form of a precipitated solid and/or in aqueous form in the leaching solution. In some embodiments, lithium carbonate may be present in the leaching slurry in both solid and aqueous forms.

The leaching process may be performed for any suitable period of time. Preferably, however, the residence time of the leaching process may be between about 1 hours and about 300 hours. More preferably, the residence time of the leaching process may be between about 2 hours and about 200 hours. More preferably, the residence time of the leaching process may be between about 3 hours and about 100 hours. It will be understood that the residence time may be dependent on a number of factors, such as the nature of the lithium bearing material, the temperature at which the leaching process is conducted, the concentration of carbonate ions in the lixiviant, the particle size of the lithium bearing material, the concentration of solids in solutions, and so on.

The leaching process may be performed as a batch process or as a continuous process. Preferably, however, the leaching process may be a continuous process.

In some embodiments of the invention, the leaching slurry may be treated to recover heat at the conclusion of the leaching process. Heat may be recovered using any suitable technique, although in a preferred embodiment, heat may be recovered using a heat exchange process. The heat exchange fluid used to recover heat from the leaching slurry may be of any suitable form. In some embodiments of the invention, the heat exchange fluid may be a process stream generated or used in another part of the method.

Most preferably, the heat exchange process exchanges the hot leach slurry discharge with colder bicarbonate solutions produced from the leaching process.

As previously stated, a carbonation process is performed on the leaching slurry to convert at least a portion of the lithium carbonate in the leaching slurry to lithium bicarbonate. The carbonation process may be performed using any suitable reactant, although in a preferred embodiment of the invention, the reactant may be a gas containing carbon. In a particular embodiment, the reactant may comprise carbon dioxide.

It is envisaged that the lithium carbonate converted to lithium bicarbonate may be the solid lithium carbonate in the leaching slurry, the aqueous lithium carbonate, or a combination of the two. Preferably, lithium carbonate is converted to lithium bicarbonate according to the following reaction:

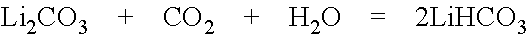

The carbonation process may be performed at any suitable temperature, and it is envisaged that the temperature may be chosen to enhance the solubility of the lithium bicarbonate. In a preferred embodiment of the invention, the carbonation process may be performed at a temperature of no more than about 70° C. More preferably, the carbonation process may be performed at a temperature of no more than about 60° C. Most preferably, the carbonation process may be performed at a temperature of no more than about 50° C.

The carbonation process may be performed at any suitable pressure, including at atmospheric pressure, or at greater than atmospheric pressure.

The carbonation process may be performed as a continuous process or as a batch process and may be performed in any suitable vessel, such as, but not limited to, autoclaves, adsorption towers, deep stirred tanks or any suitable combination thereof. In a particular embodiment of the invention, the vessel comprises a deep atmospheric stirred tank.

Preferably, the carbonation process may extract at least 70% of the lithium in the leaching slurry. More preferably, the carbonation process may extract at least 80% of the lithium in the leaching slurry. Even more preferably, the carbonation process may extract at least 90% of the lithium in the leaching slurry. In some embodiments, the carbonation process may extract approximately 95% of the lithium in the leaching slurry. It is envisaged that at least a portion of the lithium that is not extracted by the carbonation process may not be in the form of lithium carbonate but may be present as residual alpha spodumene from the carbonate leaching step, and therefore may not be available for carbonate dissolution.

Following the carbonation process, a solid-liquid separation process is performed on the leaching slurry from the carbonation process to separate a leach residue from the leaching solution. In this way, a lithium leaching solution that is relatively free of solids may be obtained. More preferably, the lithium leaching solution is substantially entirely free of solids.

Any suitable solid-liquid separation process may be used. For instance, the solid-liquid separation process may comprise a filtration process, an evaporation or drying process or the like. In other embodiments, a settling or counter current decantation process (such as one conducted in a thickener) may be performed to separate a clarified leaching solution from the solid leaching residue.

In some embodiments of the invention, the leaching residue may, once separated from the leaching solution, be washed or otherwise cleaned in order to remove at least a portion of soluble species present thereon. The leaching residue may be washed or otherwise cleaned once, or may be washed or cleaned during two or more steps in the method.

It is envisaged that the leaching residue may form a tailings product from the extraction method. Beneficially, however, it is envisaged that, rather than being disposed of, the leaching residue may constitute a byproduct that is suitable for transportation or environmental storage. Preferably, the tailings from the leaching residue are filtered to produce a filtered tailings product.

Thus, the present invention provides a significant advantage in that, instead of generating a potentially hazardous tailings product that must be stored or otherwise disposed of, the present invention generates a non-hazardous byproduct that can be stored environmentally or transported safely for relocation.

In some embodiments of the invention, the non-hazardous byproduct may provide material for a cement filler admixture. The material may be in the form of an industrial mineral, and may be for industrial use.

After the solid-liquid separation process, the leaching solution is relatively free from solids and has a relatively high soluble lithium concentration. Lithium may then be obtained from the leaching solution in the form of lithium carbonate by altering the solution chemistry. While lithium carbonate may be obtained using any suitable technique, in one embodiment of the invention, the solid lithium carbonate is obtained via a precipitation reaction.

Any suitable precipitation reaction may be used, although in a preferred embodiment of the invention a compound may be introduced to the leaching solution in order to convert soluble lithium bicarbonate to relatively insoluble lithium carbonate. Any suitable compound may be used, although in a preferred embodiment, the compounds is a hydroxide compound (such as sodium hydroxide, potassium hydroxide and the like). More preferably, the hydroxide compound may comprise a sodium compound. In this embodiment of the invention, the lithium carbonate precipitation proceeds according to the following reaction:

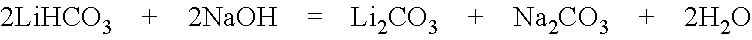

Beneficially, the use of sodium hydroxide results in a leaching solution containing aqueous sodium carbonate. Thus, once the precipitated lithium carbonate is separated from the leaching solution, the leaching solution may be returned to the leaching process as the lixiviant.

In a preferred embodiment of the invention, the precipitation of lithium carbonate may be conducted at an elevated temperature. Preferably, the precipitation of lithium carbonate may be performed at a temperature of between about 30° C. and 99° C. At these temperatures, it is envisaged that a further reaction may occur that results in the precipitation of lithium carbonate. This reaction proceeds according to the following reaction:

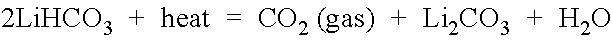

In some embodiments of the invention, the temperature of the leaching solution may be elevated using a heat source, such as a burner, heater or the like. In an alternative embodiment, the temperature of the leaching solution may be elevated using a heat exchange process. The heat exchange fluid may be of any suitable type, although in a preferred embodiment of the invention, the heat exchange fluid may comprise leaching slurry leaving the leaching process. In this way, the leaching slurry leaving the leaching process may be cooled and the leaching solution undergoing lithium carbonate precipitation may be heated, thereby reducing or eliminating the need for an external heat source.

The precipitation process may be conducted in any suitable vessel. Preferably, however, the vessel comprises a reactor or tank. In a particular embodiment of the invention, the vessel comprises tank or batch reactors. In some embodiments of the invention, the reactors may be agitated. In a specific embodiment of the invention, the reactors may be continuously stirred.

Precipitated lithium carbonate may be separated from the leaching solution using any suitable technique. For instance, the precipitated lithium carbonate may be separated using a filtration process, an evaporation or drying process or the like. In other embodiments of the invention, a settling or thickening process may be performed to separate a clarified leaching solution from the precipitated lithium carbonate.

Preferably, the precipitated lithium carbonate is separated using filtration to provide a filter cake. In some embodiments of the invention, the filtered, precipitated lithium carbonate may be washed with water to provide a moist lithium carbonate filter cake.

Ideally, the filtrate solution from the separation process may be recycled as carbonate leaching solution. The carbonate solution will contain sodium carbonate and at least trace quantities of lithium carbonate, which may be beneficially recycled to the atmospheric leaching process.

It has been found that the extraction method of the present invention results in at least a comparable recovery of lithium from the lithium bearing material compared to conventional extraction processes. In addition, the lithium carbonate product produced by the method is of a relatively high purity. Further, the present method generates streams that may be recycled to other points in the process, thereby reducing reagent costs, as well as reducing the requirement for thermal energy to be provided from an external source (and the costs associated with this). Finally, and as previously mentioned, the present invention generates a non-hazardous byproduct.

In a third aspect, the invention resides broadly in a method for the extraction of lithium, the method comprising the steps of:
Subjecting a lithium bearing material to a first leaching process at atmospheric pressure in the presence of carbonate ions to produce lithium carbonate;
Subjecting the lithium carbonate to a second leaching process in the presence of hydroxide ions to produce a leaching slurry containing an aqueous solution of lithium hydroxide;
Separating a solid leach residue from the leaching solution to produce a lithium hydroxide solution that is relatively free of solids; and
Producing a solid lithium hydroxide product from the lithium hydroxide solution that is relatively free of solids.

The lithium bearing material may be of any suitable form. For instance, the lithium bearing material may comprise an ore, a concentrate, a residue or waste product or the like, or any suitable combination thereof. Preferably, however, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally-occurring materials (such as lithium ores and mineral concentrates), while beta spodumene is more likely to be present in materials such as thermally processed concentrates and the like.

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal processing step. Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of lithium minerals present in the lithium bearing material, the particle size of the lithium bearing material, the minerals present in the lithium bearing material and so on.

The thermal processing step may be performed as a batch process or as a continuous process. In a preferred embodiment of the invention the lithium bearing material may be cooled following the thermal processing step, and prior to further processing of the lithium bearing material.

In some embodiments of the invention, the lithium bearing material that has undergone the thermal processing step may be subject to one or more comminution processes and/or one or more classification process prior to the leaching process. In a preferred embodiment of the invention, relatively fine particles of the lithium bearing material may be introduced to the leaching process.

It is envisaged that a significant proportion of the alpha spodumene present in the lithium bearing material may be converted to beta spodumene in the thermal processing step. In some embodiments, at least 70% of the alpha spodumene present in the lithium bearing material may be converted to beta spodumene in the thermal processing step. More preferably, at least 80% of the alpha spodumene present in the lithium bearing material may be converted to beta spodumene in the thermal processing step. More preferably, at least 90% of the alpha spodumene present in the lithium bearing material may be converted to beta spodumene in the thermal processing step. In some embodiments of the invention, it is envisaged that between about 93% and about 96% of the alpha spodumene present in the lithium bearing material may be converted to beta spodumene in the thermal processing step. Thus, in this embodiment, a significant proportion of the lithium present in the lithium bearing material that is subjected to the leaching process is in the form of beta spodumene.

As previously stated, the leaching of the lithium bearing material is performed at atmospheric pressure. It will be understood that the term “atmospheric pressure” refers to a pressure that is approximately equal to atmospheric pressure at sea level, or less than about 101.325 kPa. It will be understood, however, that relatively small variations to this pressure are intended to be encompassed within the meaning of the term “atmospheric pressure” that such the term atmospheric pressure may include leaching conducted under a slightly pressurised atmosphere, or under a slight vacuum. For instance, the vessel in which the leaching of the lithium bearing material is performed may be capable of operating at pressures above or below atmospheric pressure.

It will be understood, however, that the vessel may comprise a sealed vessel capable of pressures above or below atmospheric pressure. In some embodiments of the invention, the vessel may comprise a vacuum to manage vapour loss and/or air ingress.

The leaching process may be conducted in any suitable vessel. Preferably, however, the vessel comprises a tank, reactor, or the like. In a particular embodiment of the invention, the vessel may comprise a reactor, such as a tank or batch reactor. In some embodiments of the invention, the reactor may be agitated. In a specific embodiment, the reactor may be continuously stirred.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 50° C. but less than 160° C. More preferably, the leaching of the lithium bearing material is performed at a temperature of greater than 60° C. but less than 160° C. More preferably, the leaching of the lithium bearing material is performed at a temperature of greater than 70° C. but less than 160° C. Most preferably, the leaching of the lithium bearing material is performed at a temperature of greater than 80° C. but less than 160° C.

Preferably, the temperature at which the leaching of the lithium bearing material is performed is configured to be below the boiling point of the leaching solution.

It is envisaged that the lithium bearing material may be introduced to the leaching process in the form of solid material. As previously stated, the lithium bearing material is leached in the presence of carbonate ions. Preferably, the lixiviant comprises carbonate anions and alkali metal cations. Any suitable alkali metal cations may be present, although in a preferred embodiment of the invention, the alkali metal cations may comprise sodium ions. It will be understood that the lixiviant may comprise anions other than carbonate. For instance, the lixiviant may comprise bicarbonate ions.

The lixiviant may have any suitable concentration of carbonate ions. For instance, the concentration of carbonate ions in the lixiviant may be between about 17 g/L and 288 g/L. More preferably, the concentration of carbonate ion in the lixiviant may be between about 12 g/L and 230 g/L. Most preferably, the concentration of carbonate ions in the lixiviant may be between about 6 g/L and 173 g/L.

The lixiviant may have any suitable concentration of carbonate ions. For instance, the concentration of carbonate ions in the lixiviant may be between about 6 g/L and 288 g/L. More preferably, the concentration of carbonate ion in the lixiviant may be between about 12 g/L and 230 g/L. Most preferably, the concentration of carbonate ions in the lixiviant may be between about 17 g/L and 173 g/L.

In a particular embodiment of the invention, the carbonate ions may be added as sodium carbonate. For instance, the concentration of sodium carbonate in the lixiviant may be between about 10 g/L and 500 g/L. More preferably, the concentration of sodium carbonate in the lixiviant may be between about 20 g/L and 400 g/L. Most preferably, the concentration of sodium carbonate in the lixiviant may be between about 30 g/L and 300 g/L.

The lixiviant may have any suitable concentration of sodium ions. For instance, the concentration of sodium ions in the lixiviant may be between about 4 g/L and 217 g/L. More preferably, the concentration of sodium ion in the lixiviant may be between about 9 g/L and 174 g/L. Most preferably, the concentration of sodium ions in the lixiviant may be between about 13 g/L and 130 g/L.

In a particular embodiment of the invention, the carbonate ions may be added as potassium carbonate. For instance, the concentration of potassium carbonate in the lixiviant may be between about 10 g/L and 1000 g/L. More preferably, the concentration of potassium carbonate in the lixiviant may be between about 30 g/L and 600 g/L. Most preferably, the concentration of potassium carbonate in the lixiviant may be between about 50 g/L and 300 g/L.

In a particular embodiment of the invention, the leaching of lithium bearing material (in the form of beta spodumene) may proceed according to the following reaction:

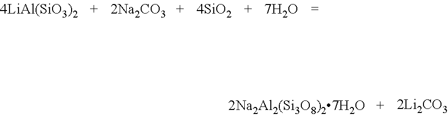

In this embodiment, it is envisaged that the leaching reaction may result in the extraction of lithium from the beta spodumene through the exchange of lithium and sodium ions. The sodium aluminium silicate present in the leaching slurry may be in the form of a solid, while the lithium carbonate generated by the leaching reaction may be present in the form of a precipitated solid and/or in aqueous form in the leaching solution. In some embodiments, lithium carbonate may be present in the leaching slurry in both solid and aqueous forms.

The leaching process may be performed for any suitable period of time. Preferably, however, the residence time of the leaching process may be between about 1 hours and about 300 hours. More preferably, the residence time of the leaching process may be between about 2 hours and about 200 hours. More preferably, the residence time of the leaching process may be between about 3 hours and about 100 hours. It will be understood that the residence time may be dependent on a number of factors, such as the nature of the lithium bearing material, the temperature at which the leaching process is conducted, the concentration of carbonate ions in the lixiviant, the particle size of the lithium bearing material, the concentration of solids in solutions, and so on.

The leaching process may be performed as a batch process or as a continuous process. Preferably, however, the leaching process may be a continuous process.

In some embodiments of the invention, the leaching slurry may be treated to recover heat at the conclusion of the leaching process. Heat may be recovered using any suitable technique, although in a preferred embodiment, heat may be recovered using a heat exchange process. The heat exchange fluid used to recover heat from the leaching slurry may be of any suitable form. In some embodiments of the invention, the heat exchange fluid may be a process stream generated or used in another part of the method.

As previously stated, the lithium carbonate is subjected to a second leaching process in the presence of hydroxide ions to produce a leaching solution containing an aqueous solution of lithium hydroxide. However, before the second leaching process takes place, one or more process steps may be performed on the stream exiting the first leaching process.

In particular, it is envisaged that the stream exiting the first leaching process may comprise leached solids, including lithium carbonate. Thus, in some embodiments of the invention, a solid-liquid separation process may be performed on the stream exiting the first leaching process.

Any suitable solid-liquid separation process may be used. For instance, the solid-liquid separation process may comprise a filtration process, an evaporation or drying process or the like. In other embodiments, a settling process or a counter current decantation process (such as one conducted in a thickener) may be performed to separate a clarified solution from the leached solids.

In some embodiments of the invention, the leached solids may, once separated from the clarified solution, be washed or otherwise cleaned in order to remove at least a portion of soluble species present thereon.

The leached solids (including the lithium carbonate) may be subjected to the second leaching process. The second leaching process may be conducted at any suitable pressure, including at greater than atmospheric pressure. In some embodiments of the invention, the second leaching process may be conducted at atmospheric pressure.

The second leaching process may be performed at any suitable temperature, and it is envisaged that the temperature may be chosen to enhance the solubility of the lithium. In a preferred embodiment of the invention, the second leaching process may be performed at a temperature of no more than about 70° C. More preferably, the second leaching process may be performed at a temperature of no more than about 60° C. Most preferably, the second leaching process may be performed at a temperature of no more than about 50° C.

As previously stated, the second leaching process is conducted in the presence of hydroxide ions. Preferably, the second leaching process is conducted in the presence of cations that form substantially insoluble carbonate compounds. For instance, the second leaching process may be conducted in the presence of cations of barium, calcium, strontium and/or magnesium. Thus, in this embodiment of the invention, the cation component of the lixiviant is selected to be substantially insoluble when combined with the carbonate anion from the lithium carbonate. In this way, contamination of the leaching solution by carbonate ions and undesirable cations may be reduced or eliminated. In this embodiment of the invention, it is envisaged that at least a portion of the products of the second leaching process may be precipitated, calcium carbonate, barium carbonate, strontium carbonate and/or magnesium carbonate and an aqueous solution of lithium hydroxide.

The second leaching process may be performed for any suitable period of time. Preferably, however, the residence time of the second leaching process may be between about 0.5 hours and about 5 hours. More preferably, the residence time of the second leaching process may be between about 1 hours and about 3 hours. More preferably, the residence time of the second leaching process may be between about 1 hours and about 2 hours. It will be understood that the residence time may be dependent on a number of factors, such as the nature of the lithium bearing material, the temperature at which the second leaching process is conducted, the concentration of hydroxide ions in the lixiviant, the particle size of the lithium bearing material, the concentration of solids in solutions, and so on.

The second leaching process may be performed as a batch process or as a continuous process. Preferably, however, the second leaching process may be a continuous process.

The step of separating the solid leach residue to produce a lithium hydroxide solution that is relatively free of solids may be performed using any suitable technique. Preferably, a solid-liquid separation process may be performed to separate the solid leach residue from the lithium hydroxide solution that is relatively free of solids.

Any suitable solid-liquid separation process may be used. For instance, the solid-liquid separation process may comprise a filtration process, an evaporation or drying process or the like. In other embodiments, a settling process or a counter current decantation process (such as one conducted in a thickener) may be performed to separate the lithium hydroxide solution that is relatively free of solids from the solid leach residue.

In some embodiments of the invention, the solid leach residue may, once separated from the lithium hydroxide solution that is relatively free of solids, be washed or otherwise cleaned in order to remove at least a portion of soluble species present thereon.

It is envisaged that the solid leach residue may form a tailings product from the extraction method. Beneficially, however, it is envisaged that the solid leach residue may constitute a non-hazardous byproduct comprising some portion of calcite and/or one or more zeolites (sodium aluminium silicates).

As previously stated, a solid lithium hydroxide product is produced from the lithium hydroxide solution that is relatively free of solids. The solid lithium hydroxide product may be of any suitable form, and may be anhydrous or hydrated. In some embodiments of the invention, the solid lithium hydroxide product may be in the form of crystalline lithium hydroxide.

The solid lithium hydroxide product may be produced directly from the lithium hydroxide solution that is relatively free of solids, or the lithium hydroxide solution that is relatively free of solids may undergo one or more additional processing steps prior to the production of the solid lithium hydroxide product.

For instance, the lithium hydroxide solution that is relatively free of solids may undergo a purification step prior to the production of the solid lithium hydroxide product. Any suitable purification process may be used, although in some embodiments of the invention, the lithium hydroxide solution may be partially evaporated to crystallise relatively high purity lithium hydroxide monohydrate. Alternatively, or in addition to, the lithium hydroxide solution may be subjected to a crystallisation process, such as vapour recompression crystallisation to produce lithium hydroxide crystals forming the solid lithium hydroxide product. In some embodiments, the purification step may include an ion exchange process, such as an ion exchange process to remove di- and tri-valent cations before subjecting the lithium hydroxide solution stream to a crystallisation process.

In a fourth aspect, the invention resides broadly in a method for the extraction of lithium, the method comprising the steps of:
Subjecting an alpha spodumene containing material to a conversion process at atmospheric pressure to convert at least a portion of the alpha spodumene to beta spodumene
Subjecting the beta spodumene to a leaching process at atmospheric pressure in the presence of carbonate ions to produce a leaching solution and leached solids containing lithium carbonate;
Subjecting the leached solids containing lithium carbonate to a size reduction and/or classification process in a solution containing the carbonate ions to generate a leaching slurry containing relatively fine solids;
Performing a carbonation process on the leaching slurry to convert at least a portion of the lithium carbonate to lithium bicarbonate;
Performing a solid-liquid separation process on the leaching slurry to separate a leach residue from a leaching solution;
Obtaining solid lithium carbonate from the leaching solution; and
Separating the solid lithium carbonate from the leaching solution.

The lithium bearing material may be of any suitable form. For instance, the lithium bearing material may comprise an ore, a concentrate, a residue or waste product or the like, or any suitable combination thereof. Preferably, however, at least a portion of the lithium in the lithium bearing material is present in the form of spodumene, one or more zeolites or the like, or a combination thereof.

The spodumene present in the lithium bearing material may be in the form of alpha spodumene, beta spodumene or a combination thereof. It is envisaged that alpha spodumene is more likely to be present in naturally occurring materials (such as lithium ores and mineral concentrates), while beta spodumene is more likely to be present in materials such as thermally processed concentrates and the like.

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal processing step. Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment of the invention, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of lithium minerals present in the lithium bearing material, the particle size of the lithium bearing material, the minerals present in the lithium bearing material and so on.

The thermal processing step may be performed as a batch process or as a continuous process. In a preferred embodiment of the invention the lithium bearing material may be cooled following the thermal processing step, and prior to further processing of the lithium bearing material.

In some embodiments of the invention, the lithium bearing material that has undergone the thermal processing step may be subject to one or more comminution processes and/or one or more classification process prior to the leaching process. In a preferred embodiment of the invention, relatively fine particles of the lithium bearing material may be introduced to the leaching process.

It is envisaged that a significant proportion of the alpha spodumene present in the lithium bearing material may be converted to beta spodumene in the thermal processing step. In some embodiments of the invention, at least 70% of the alpha spodumene present in the lithium bearing material may be converted to beta spodumene in the thermal processing step. More preferably, at least 80% of the alpha spodumene present in the lithium bearing material may be converted to beta spodumene in the thermal processing step. More preferably, at least 90% of the alpha spodumene present in the lithium bearing material may be converted to beta spodumene in the thermal processing step. In some embodiments of the invention, it is envisaged that between about 93% and about 96% of the alpha spodumene present in the lithium bearing material may be converted to beta spodumene in the thermal processing step. Thus, in this embodiment of the invention, a significant proportion of the lithium present in the lithium bearing material that is subjected to the leaching process is in the form of beta spodumene.

As previously stated, the leaching of the lithium bearing material is performed at atmospheric pressure. It will be understood that the term “atmospheric pressure” refers to a pressure that is approximately equal to atmospheric pressure at sea level, or less than about 101.325 kPa at sea level. It will be understood, however, that relatively small variations to this pressure are intended to be encompassed within the meaning of the term “atmospheric pressure” that such the term atmospheric pressure may include leaching conducted under a slightly pressurised atmosphere, or under a slight vacuum. For instance, the vessel in which the leaching of the lithium bearing material is performed may be capable of operating at pressures above or below atmospheric pressure.

It will be understood, however, that the vessel may comprise a sealed vessel capable of pressures above or below atmospheric pressure. In some embodiments of the invention, the vessel may comprise a vacuum to manage vapour loss and/or air ingress.

The leaching process may be conducted in any suitable vessel. Preferably, however, the vessel comprises a tank, reactor, or the like. In a particular embodiment of the invention, the vessel may comprise a reactor, such as a tank or batch reactor. In some embodiments of the invention, the reactor may be agitated. In a specific embodiment, the reactor may be continuously stirred.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 50° C. but less than 160° C. More preferably, the leaching of the lithium bearing material is performed at a temperature of greater than 60° C. but less than 160° C. More preferably, the leaching of the lithium bearing material is performed at a temperature of greater than 70° C. but less than 160° C. Most preferably, the leaching of the lithium bearing material is performed at a temperature of greater than 80° C. but less than 160° C.

Preferably, the temperature at which the leaching of the lithium bearing material is performed is configured to be below the boiling point of the leaching solution.

The temperature may be controlled using any suitable method. In some embodiments of the invention, temperature control may be performed using an electrical heating apparatus, direct steam injection, or indirect steam heating. In some embodiments, the temperature of the leaching process may be at least partially controlled via an exchange of heat (and the subsequent recovery of heat) between a relatively cool leach solution recycled from another point in the method and the relatively hot leach slurry leaving the leaching process.

It is envisaged that the lithium bearing material may be introduced to the leaching process in the form of solid material. As previously stated, the lithium bearing material is leached in the presence of carbonate ions. Preferably, the lithium bearing material is introduced to a lixiviant containing carbonate ions and, in particular, an aqueous solution of carbonate.

Most preferably, the lithium bearing material will be beta spodumene. It is envisaged that the beta spodumene may be provided at an elevated temperature. In some embodiment of the invention, the temperature of the beta spodumene may be elevated due to the elevated temperatures used in the roasting or calcining process.

Preferably, the lixiviant comprises carbonate anions and alkali metal cations. Any suitable alkali metal cations may be present, although in a preferred embodiment of the invention, the alkali metal cations may comprise sodium ions. It will be understood that the lixiviant may comprise anions other than carbonate. For instance, the lixiviant may comprise bicarbonate ions.

The lixiviant may have any suitable concentration of carbonate ions. For instance, the concentration of carbonate ions in the lixiviant may be between about 6 g/L and 288 g/L. More preferably, the concentration of carbonate ion in the lixiviant may be between about 12 g/L and 230 g/L. Most preferably, the concentration of carbonate ions in the lixiviant may be between about 17 g/L and 173 g/L.

In a particular embodiment of the invention, the carbonate ions may be added as sodium carbonate. For instance, the concentration of sodium carbonate in the lixiviant may be between about 10 g/L and 500 g/L. More preferably, the concentration of sodium carbonate in the lixiviant may be between about 20 g/L and 400 g/L. Most preferably, the concentration of sodium carbonate in the lixiviant may be between about 30 g/L and 300 g/L.

In a particular embodiment of the invention, the leaching of lithium bearing material (in the form of beta spodumene) may proceed according to the following reaction:

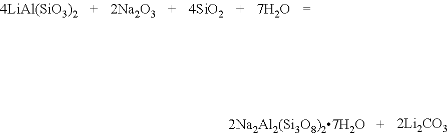

In this embodiment of the invention, it is envisaged that the leaching reaction may result in the extraction of lithium from the beta spodumene through the exchange of lithium and sodium ions. The sodium aluminium silicate present in the leaching slurry from the leaching reaction may be in the form of a solid, while the lithium carbonate generated by the leaching reaction may be present in the form of a precipitated solid and/or in aqueous form in the leaching slurry. In some embodiments of the invention, lithium carbonate may be present in the leaching slurry in both solid and aqueous forms.

The leaching process may be performed for any suitable period of time. Preferably, however, the residence time of the leaching process may be between about 1 hour and about 300 hours. More preferably, the residence time of the leaching process may be between about 2 hours and about 200 hours. More preferably, the residence time of the leaching process may be between about 3 hours and about 100 hours. It will be understood that the residence time may be dependent on a number of factors, such as the nature of the lithium bearing material, the temperature at which the leaching process is conducted, the concentration of carbonate ions in the lixiviant, the concentration of sodium ions in the lixiviant, the particle size of the lithium bearing material, the concentration of solids in solutions, and so on.

The leaching process may be performed as a batch process or as a continuous process. Preferably, however, the leaching process may be a continuous process.

In some embodiments of the invention, the leaching slurry may be treated to recover heat at the conclusion of the leaching process. Heat may be recovered using any suitable technique, although in a preferred embodiment of the invention, heat may be recovered using a heat exchange process. The heat exchange fluid used to recover heat from the leaching slurry may be of any suitable form. In some embodiments of the invention, the heat exchange fluid may be a process stream generated or used in another part of the method.

In some embodiments of the invention, the leaching slurry containing lithium carbonate in solid and aqueous forms may undergo a size reduction and/or classification process. The size reduction process may be performed using any suitable method, such as ball milling, vertical stir milling, jet milling, or any other suitable size reduction technique. The size reduction process may be performed as a wet or dry process, but in the preferred embodiment of the invention, the size reduction process may be a wet grinding process. Preferably, the size reduction process may generate a stream containing relatively fine particles relative to the feed to the leach circuit.

It is envisaged that the size reduction process may reduce the particle size of the beta spodumene present in the leach slurry.

In embodiments of the invention in which a classification process is used, it is envisaged that any suitable classification process may be used. However, it is envisaged that the classification process may classify solid particles on the basis of particle size (such as through the use of spiral classifiers, cone classifiers, hydrocyclones, hydraulic classifiers or the like). Thus, it is envisaged that the classification process may generate a stream containing relatively fine particles and a stream containing relatively coarse particles.

In some embodiments of the invention, the size reduction process may include a classification process.

It is envisaged that the stream of relatively coarse particles from the size reduction and/or classification process may be recycled to the size reduction and/or classification process in order to generate further relatively fine particles.

It is envisaged that the relatively fine particles in carbonate solution may undergo a second leaching process, substantially the same as the first leaching process.

As previously stated, a carbonation process is performed on the leaching slurry to convert at least a portion of the lithium carbonate in the leaching slurry to lithium bicarbonate. The carbonation process may be performed using any suitable reactant, although in a preferred embodiment of the invention, the reactant may be a gas containing carbon. In a particular embodiment, the reactant may comprise carbon dioxide.

It is envisaged that the lithium carbonate converted to lithium bicarbonate may come from the solid lithium carbonate in the leaching slurry, the aqueous lithium carbonate, or a combination of the two. Preferably, lithium carbonate is converted to lithium bicarbonate according to the following reaction:

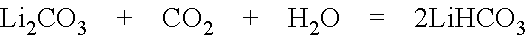

The carbonation process may be performed at any suitable temperature, and it is envisaged that the temperature may be chosen to enhance the solubility of the lithium bicarbonate. In a preferred embodiment of the invention, the carbonation process may be performed at a temperature of no more than about 70° C. More preferably, the carbonation process may be performed at a temperature of no more than about 60° C. Most preferably, the carbonation process may be performed at a temperature of no more than about 50° C.

The carbonation process may be performed at any suitable pressure, including at atmospheric pressure, or at greater than atmospheric pressure.

The carbonation process may be performed as a continuous process or as a batch process and may be performed in any suitable vessel, such as, but not limited to, autoclaves, adsorption towers, deep stirred tanks or any suitable combination thereof. In a particular embodiment of the invention, the vessel comprises a deep atmospheric stirred tank.

Preferably, the carbonation process may extract at least 70% of the lithium in the leaching slurry. More preferably, the carbonation process may extract at least 80% of the lithium in the leaching slurry. Even more preferably, the carbonation process may extract at least 90% of the lithium in the leaching slurry. In some embodiments, the carbonation process may extract approximately 95% of the lithium in the leaching slurry. It is envisaged that at least a portion of the lithium that is not extracted by the carbonation process may not be in the form of lithium carbonate but may be present as residual alpha spodumene from the carbonate leaching step, and therefore may not be available for carbonate dissolution.

In a preferred embodiment of the invention, substantially all of the lithium carbonate in the leaching slurry may be converted to aqueous lithium bicarbonate in the carbonation process. In this way, any solid leach residue in the leaching slurry following the carbonation process may contain no, or relatively little, lithium.

Following the carbonation process, a solid-liquid separation process is performed on the leaching slurry from the carbonation process to separate a leach residue from the leaching solution. In this way, a lithium leaching solution that is relatively free of solids may be obtained.

Any suitable solid-liquid separation process may be used. For instance, the solid-liquid separation process may comprise a filtration process, an evaporation or drying process or the like. In other embodiments, a settling or counter current decantation process (such as one conducted in a thickener) may be performed to separate a clarified leaching solution from the solid leaching residue.

In some embodiments of the invention, the leaching residue may, once separated from the leaching solution, be washed or otherwise cleaned in order to remove at least a portion of soluble species present thereon.

It is envisaged that the leaching residue may form a tailings product from the extraction method. Beneficially, however, it is envisaged that, rather than being disposed of, the leaching residue may constitute a byproduct that can be stored environmentally or transported safely for relocation.

Preferably, the tailings from the leaching residue are filtered to produce a filtered tailings product.

Thus, the present invention provides a significant advantage in that, instead of generating a potentially hazardous tailings product that must be stored or otherwise disposed of, the present invention generates a non-hazardous byproduct that can be stored environmentally or transported safely for relocation.

After the solid-liquid separation process, the leaching solution is relatively free from solids and has a relatively high lithium concentration. Lithium may then be obtained from the leaching solution in the form of lithium carbonate by altering the solution chemistry. While lithium carbonate may be obtained using any suitable technique, in one embodiment of the invention, the solid lithium carbonate is obtained via a precipitation reaction.

Any suitable precipitation reaction may be used, although in a preferred embodiment of the invention a compound may be introduced to the leaching solution in order to convert soluble lithium bicarbonate to relatively insoluble lithium carbonate. Any suitable compound may be used, although in a preferred embodiment, the compounds is a hydroxide compound (such as sodium hydroxide, potassium hydroxide and the like). More preferably, the hydroxide compound may comprise a sodium compound. In this embodiment of the invention, the lithium carbonate precipitation proceeds according to the following reaction:

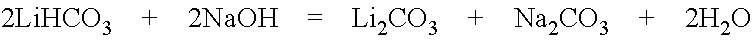

Beneficially, the use of sodium hydroxide results in a leaching solution containing aqueous sodium carbonate. Thus, once the precipitated lithium carbonate is separated from the leaching solution, the leaching solution may be returned to the leaching process as the lixiviant.

In a preferred embodiment of the invention, the precipitation of lithium carbonate may be conducted at an elevated temperature. Preferably, the precipitation of lithium carbonate may be performed at a temperature of between about 30° C. and 99° C. At these temperatures, it is envisaged that a further reaction may occur that results in the precipitation of lithium carbonate. This reaction proceeds according to the following reaction:

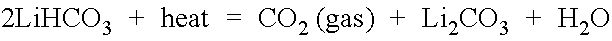

In some embodiments of the invention, the temperature of the leaching solution may be elevated using a heat source, such as a burner, heater or the like. In an alternative embodiment, the temperature of the leaching solution may be elevated using a heat exchange process. The heat exchange fluid may be of any suitable type, although in a preferred embodiment of the invention, the heat exchange fluid may comprise leaching slurry leaving the leaching process. In this way, the leaching slurry leaving the leaching process may be cooled and the leaching solution undergoing lithium carbonate precipitation may be heated, thereby reducing or eliminating the need for an external heat source.

The precipitation process may be conducted in any suitable vessel. Preferably, however, the vessel comprises a reactor or tank. In a particular embodiment of the invention, the vessel comprises a tank or batch reactor. In some embodiments of the invention, the reactors may be agitated. In a specific embodiment of the invention, the reactors may be continuously stirred.

Precipitated lithium carbonate may be separated from the leaching solution using any suitable technique. For instance, the precipitated lithium carbonate may be separated using a filtration process, an evaporation or drying process or the like. In other embodiments of the invention, a settling or thickening process may be performed to separate a clarified leaching solution from the precipitated lithium carbonate.

Preferably, the precipitated lithium carbonate is separated using filtration to provide a filter cake. In some embodiments of the invention, the filtered, precipitated lithium carbonate may be washed with water to provide a moist lithium carbonate filter cake.

Ideally, the filtrate solution from the separation process may be recycled as carbonate leaching solution. The carbonate solution will contain carbonate ions and at least trace quantities of lithium carbonate, which may be beneficially recycled to the atmospheric leaching process.

In a fifth aspect, the invention resides broadly in a method for the extraction of lithium, the method comprising the steps of:
Subjecting an alpha spodumene containing material to a conversion process at atmospheric pressure to convert at least a portion of the alpha spodumene to beta spodumene;
Subjecting the beta spodumene to a grinding process to produce ground beta spodumene;
Subjecting the ground beta spodumene to a leaching process at atmospheric pressure in the presence of carbonate ions to produce a leaching slurry containing lithium carbonate and leached solids;
Performing a carbonation process on the leaching slurry to convert at least a portion of the lithium carbonate to lithium bicarbonate;
Performing a solid-liquid separation process on the leaching slurry to separate a leach residue from a leaching solution;
Obtaining solid lithium carbonate from the leaching solution; and
Separating the solid lithium carbonate from the leaching solution.

The lithium bearing material may be of any suitable form. For instance, the lithium bearing material may comprise an ore, a concentrate, a residue or waste product or the like, or any suitable combination thereof. Preferably, however, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally occurring materials (such as lithium ores and mineral concentrates), while beta spodumene is more likely to be present in materials such as thermally processed concentrates and the like.

In some embodiments of the invention, the lithium bearing material may undergo one or more treatment steps prior to the leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal treatment step.

Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of lithium minerals present in the lithium bearing material, the particle size of the lithium bearing material, the minerals present in the lithium bearing material and so on.

The thermal processing step may be performed as a batch process or as a continuous process. In a preferred embodiment of the invention the lithium bearing material may be cooled following the thermal processing step, and prior to further processing of the lithium bearing material.

It is envisaged that a significant proportion of the alpha spodumene present in the lithium bearing material may be converted to beta spodumene in the thermal processing step. In some embodiments, at least 70% of the alpha spodumene present in the lithium bearing material may be converted to beta spodumene in the thermal processing step. More preferably, at least 80% of the alpha spodumene present in the lithium bearing material may be converted to beta spodumene in the thermal processing step. More preferably, at least 90% of the alpha spodumene present in the lithium bearing material may be converted to beta spodumene in the thermal processing step. In some embodiments of the invention, it is envisaged that between about 93% and about 96% of the alpha spodumene present in the lithium bearing material may be converted to beta spodumene in the thermal processing step. Thus, in this embodiment, a significant proportion of the lithium present in the lithium bearing material that is subjected to the leaching process is in the form of beta spodumene.

Preferably the beta spodumene is substantially cooled before being subjected to a size reduction or comminution process. The beta spodumene may be cooled using any suitable process. The specific manner in which the beta spodumene is cooled is not critical to the invention, although in some embodiments of the invention the beta spodumene may be subjected to a quenching process and, in particular, an atmospheric pressure quenching process. In a preferred embodiment of the invention, the cooling of the beta spodumene may reduce the temperature of the beta spodumene to between about 60° C. and 160° C. More preferably, the cooling of the beta spodumene may reduce the temperature of the beta spodumene to between about 70° C. and 160° C. Most preferably, the cooling of the beta spodumene may reduce the temperature of the beta spodumene to between about 80° C. and 160° C.

In some embodiments of the invention, the beta spodumene may be subjected to a size reduction process prior to the leaching process. Any suitable size reduction process may be used, although in a preferred embodiment of the invention the size reduction process may comprise a comminution process, such as crushing, grinding or the like. The comminution process may be performed using any suitable method, such as ball milling, vertical stirred milling, jet milling, or any other suitable mechanical grinding. The grinding process may be performed as a wet or dry process, but in the preferred embodiment, the grinding process may be a wet grinding process using recycled sodium carbonate lixiviant solution.

It is envisaged that the grinding process may reduce the particle size of the beta spodumene present in the leach slurry.

It is envisaged that the ground solids in the carbonate leaching slurry may subsequently undergo a leaching process.

As previously stated, the leaching of the lithium bearing material is performed at atmospheric pressure. It will be understood that the term “atmospheric pressure” refers to a pressure that is approximately equal to atmospheric pressure, or less than about 101.325 kPa at sea level. It will be understood, however, that relatively small variations to this pressure are intended to be encompassed within the meaning of the term “atmospheric pressure” that such the term atmospheric pressure may include leaching conducted under a slightly pressurised atmosphere, or under a slight vacuum. For instance, the vessel in which the leaching of the lithium bearing material is performed may be capable of operating at pressures above or below atmospheric pressure.

It will be understood, however, that the vessel may comprise a sealed vessel capable of pressures above or below atmospheric pressure. In some embodiments of the invention, the vessel may comprise a vacuum to manage vapour loss and/or air ingress.

The leaching process may be conducted in any suitable vessel. Preferably, however, the vessel comprises a tank, reactor, or the like. In a particular embodiment of the invention, the vessel may comprise a reactor, such as a tank or batch reactor. In some embodiments of the invention, the reactor may be agitated. In a specific embodiment, the reactor may be continuously stirred.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 60° C. More preferably, the leaching of the lithium bearing material is performed at a temperature of greater than 60° C. but less than 160° C. More preferably, the leaching of the lithium bearing material is performed at a temperature of greater than 70° C. but less than 160° C. Most preferably, the leaching of the lithium bearing material is performed at a temperature of greater than 80° C. but less than 160° C.

Preferably, the temperature at which the leaching of the lithium bearing material is performed is configured to be below the boiling point of the leaching solution.

The temperature may be controlled using any suitable method. In some embodiments of the invention, temperature control may be performed using an electrical heating apparatus, direct steam injection, or indirect steam heating. Preferably recycled leach solution undergoes heat exchange with the leached slurry for heat recovery. Most preferably, quenching heat from the calcination process is added to keep the leaching slurry temperature at or just below boiling point.

It is envisaged that the lithium bearing material may be introduced to the leaching process in the form of solid material suspended in leaching solution. As previously stated, the lithium bearing material is leached in the presence of carbonate ions. Preferably, the ground lithium bearing material is introduced to a lixiviant containing carbonate ions and, in particular, an aqueous solution of carbonate ions.

Most preferably, the lithium bearing material will be beta spodumene having an elevated temperature. It is envisaged that the temperature of the beta spodumene may be elevated as a result of the elevated temperatures used in the roasting or calcining process.

It will be understood that the lixiviant may comprise anions other than carbonate ions. For instance, the lixiviant may comprise bicarbonate ions.

Preferably, the lixiviant comprises carbonate anions and alkali metal cations. Any suitable alkali metal cations may be present, although in a preferred embodiment of the invention, the alkali metal cations may comprise sodium ions. It will be understood that the lixiviant may comprise anions other than carbonate. For instance, the lixiviant may comprise bicarbonate ions.

The lixiviant may have any suitable concentration of carbonate ions. For instance, the concentration of carbonate ions in the lixiviant may be between about 6 g/L and 280 g/L. More preferably, the concentration of carbonate ion in the lixiviant may be between about 12 g/L and 230 g/L. Most preferably, the concentration of carbonate ions in the lixiviant may be between about 17 g/L and 173 g/L.

In a particular embodiment of the invention, the carbonate ions may be added as sodium carbonate. For instance, the concentration of sodium carbonate in the lixiviant may be between about 10 g/L and 500 g/L. More preferably, the concentration of sodium carbonate in the lixiviant may be between about 20 g/L and 400 g/L. Most preferably, the concentration of sodium carbonate in the lixiviant may be between about 30 g/L and 300 g/L.

In a particular embodiment of the invention, the leaching of lithium bearing material (in the form of beta spodumene) may proceed according to the following reaction:

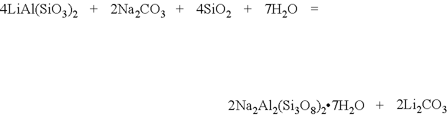

In this embodiment of the invention, it is envisaged that the leaching reaction may result in the extraction of lithium from the beta spodumene through the exchange of lithium and sodium ions. The sodium aluminium silicate present in the leaching slurry may be in the form of a solid, while the lithium carbonate generated by the leaching reaction may be present in the form of a precipitated solid and/or in aqueous form in the leaching slurry. In some embodiments of the invention, lithium carbonate may be present in the leaching slurry in both solid and aqueous forms.

The leaching process may be performed for any suitable period of time. Preferably, however, the residence time of the leaching process may be between about 1 hours and about 300 hours. More preferably, the residence time of the leaching process may be between about 2 hours and about 200 hours. More preferably, the residence time of the leaching process may be between about 3 hours and about 100 hours. It will be understood that the residence time may be dependent on a number of factors, such as the nature of the lithium bearing material, the temperature at which the leaching process is conducted, the concentration of carbonate ions in the lixiviant, the particle size of the lithium bearing material, the concentration of solids in solutions, and so on.

The leaching process may be performed as a batch process or as a continuous process. Preferably, however, the leaching process may be a continuous process.

In some embodiments of the invention, the leaching slurry may be treated to recover heat at the conclusion of the leaching process. Heat may be recovered using any suitable technique, although in a preferred embodiment of the invention, heat may be recovered using a heat exchange process. The heat exchange fluid used to recover heat from the leaching solution may be of any suitable form. In some embodiments of the invention, the heat exchange fluid may be a process stream generated or used in another part of the method.

In some embodiments of the invention, the leaching slurry containing lithium carbonate in solid and aqueous forms will undergo grinding in the sodium carbonate solution. The grinding may be performed using any suitable method, such as ball milling, vertical stirred milling, jet milling, or any mechanical grinding hereto. The grinding process may be performed wet or dry process, but in the preferred embodiment, the grinding process will be a wet grinding process. It will be understood that this grinding process may not be required if a size reduction or comminution process is performed prior to the leaching step.

It is envisaged that the grinding process will reduce the particle size of the beta spodumene present in the leach solution slurry.

As previously stated, a carbonation process is performed on the leaching slurry to convert at least a portion of the lithium carbonate in the leaching slurry to lithium bicarbonate. The carbonation process may be performed using any suitable reactant, although in a preferred embodiment of the invention, the reactant may be a gas containing carbon. In a particular embodiment of the invention, the reactant may comprise carbon dioxide.

It is envisaged that the lithium carbonate converted to lithium bicarbonate may be the solid lithium carbonate in the leaching slurry, the aqueous lithium carbonate, or a combination of the two. Preferably, lithium carbonate is converted to lithium bicarbonate according to the following reaction:

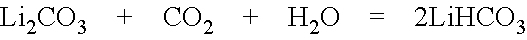

The carbonation process may be performed at any suitable temperature, and it is envisaged that the temperature may be chosen to enhance the solubility of the lithium bicarbonate. In a preferred embodiment of the invention, the carbonation process may be performed at a temperature of no more than about 70° C. More preferably, the carbonation process may be performed at a temperature of no more than about 60° C. Most preferably, the carbonation process may be performed at a temperature of no more than about 50° C.

The carbonation process may be performed at any suitable pressure, including at atmospheric pressure, or at greater than atmospheric pressure.

The carbonation process may be performed as a continuous process or as a batch process and may be performed in any suitable vessel, such as, but not limited to, autoclaves, adsorption towers, deep stirred tanks or any suitable combination thereof. In a particular embodiment of the invention, the vessel comprises a deep atmospheric stirred tank.

Preferably, the carbonation process may extract at least 70% of the lithium in the leaching slurry. More preferably, the carbonation process may extract at least 80% of the lithium in the leaching slurry. Even more preferably, the carbonation process may extract at least 90% of the lithium in the leaching slurry. In some embodiments, the carbonation process may extract approximately 95% of the lithium in the leaching slurry. It is envisaged that at least a portion of the lithium that is not extracted by the carbonation process may not be in the form of lithium carbonate but may be present as residual alpha spodumene from the carbonate leaching step, and therefore may not be available for carbonate dissolution.

In a preferred embodiment of the invention, substantially all of the lithium carbonate in the leaching slurry may be converted to aqueous lithium bicarbonate in the carbonation process. In this way, any solid leach residue in the leaching solution following the carbonation process may contain no, or relatively little, lithium.

Following the carbonation process, a solid-liquid separation process is performed on the leaching slurry from the carbonation process to separate a leach residue from the leaching solution. In this way, a lithium leaching solution that is relatively free of solids may be obtained.

Any suitable solid-liquid separation process may be used. For instance, the solid-liquid separation process may comprise a filtration process, an evaporation or drying process or the like. In other embodiments, a settling or counter current decantation process (such as one conducted in a thickener) may be performed to separate a clarified leaching solution from the solid leaching residue.

In some embodiments of the invention, the leaching residue may, once separated from the leaching solution, be washed or otherwise cleaned in order to remove at least a portion of soluble species present thereon.

It is envisaged that the leaching residue may form a tailings product from the extraction method. Beneficially, however, it is envisaged that, rather than being disposed of, the leaching residue may constitute a byproduct that is suitable for transportation or environmental storage.

Preferably, the tailings from the leaching residue are filtered to produce a filtered tailings product.

Thus, the present invention provides a significant advantage in that, instead of generating a potentially hazardous tailings product that must be stored or otherwise disposed of, the present invention generates a non-hazardous byproduct that can be stored environmentally or transported safely for relocation.

After the solid-liquid separation process, the leaching solution is relatively free from solids and has a relatively high lithium concentration. Lithium may then be obtained from the leaching solution in the form of lithium carbonate by altering the solution chemistry. While lithium carbonate may be obtained using any suitable technique, in one embodiment of the invention, the solid lithium carbonate is obtained via a precipitation reaction.

Any suitable precipitation reaction may be used, although in a preferred embodiment of the invention a compound may be introduced to the leaching solution in order to convert soluble lithium bicarbonate to relatively insoluble lithium carbonate. Any suitable compound may be used, although in a preferred embodiment, the compound is a hydroxide compound (such as sodium hydroxide). More preferably, the hydroxide compound may comprise a sodium compound. In this embodiment, the lithium carbonate precipitation proceeds according to the following reaction:

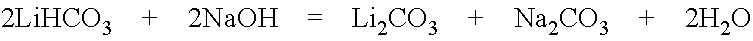

Beneficially, the use of sodium hydroxide results in a leaching solution containing aqueous sodium carbonate. Thus, once the precipitated lithium carbonate is separated from the leaching solution, the leaching solution may be returned to the leaching process as the lixiviant.

In a preferred embodiment of the invention, the precipitation of lithium carbonate may be conducted at an elevated temperature. Preferably, the precipitation of lithium carbonate may be performed at a temperature of between about 30° C. and 99° C.

In some embodiments of the invention, the temperature of the leaching solution may be elevated using a heat source, such as a burner, heater or the like. In an alternative embodiment of the invention, the temperature of the leaching solution may be elevated using a heat exchange process. The heat exchange fluid may be of any suitable type, although in a preferred embodiment of the invention, the heat exchange fluid may comprise leaching slurry leaving the leaching process. In this way, the leaching slurry leaving the leaching process may be cooled and the leaching solution undergoing lithium carbonate precipitation may be heated, thereby reducing or eliminating the need for an external heat source.

The precipitation process may be conducted in any suitable vessel. Preferably, however, the vessel comprises a reactor or tank. In a particular embodiment of the invention, the vessel may comprise a tank or batch reactor. In some embodiments of the invention, the reactors may be agitated. In a specific embodiment of the invention, the reactors may be continuously stirred.

Precipitated lithium carbonate may be separated from the leaching solution using any suitable technique. For instance, the precipitated lithium carbonate may be separated using a filtration process, an evaporation or drying process or the like. In other embodiments of the invention, a settling or thickening process may be performed to separate a clarified leaching solution from the precipitated lithium carbonate.

Preferably, the precipitated lithium carbonate is separated using filtration to provide a filter cake. In some embodiments of the invention, the filtered precipitated lithium carbonate may be washed with water to provide a moist lithium carbonate filter cake.

Preferably, the filtrate solution from the separation process may be recycled as carbonate leaching solution. The carbonate solution may contain sodium carbonate and at least trace quantities of lithium carbonate, which are beneficially recycled to the atmospheric leaching process.

In a sixth aspect, the invention resides broadly in a method for the extraction of lithium, the method comprising the steps of:

Subjecting a lithium bearing material containing beta spodumene to a leaching process at atmospheric pressure in the presence of carbonate ions to produce a leaching slurry including lithium carbonate;
Performing a carbon dioxide leaching process on the leaching slurry to produce a bicarbonate leaching slurry in which at least a portion of the lithium carbonate is converted to lithium bicarbonate;
Performing a solid-liquid separation process on the bicarbonate leaching slurry to separate a leach residue from a leaching solution;
Precipitating lithium carbonate from the leaching solution; and
Separating precipitated lithium carbonate from the leaching solution.

The lithium bearing material may be of any suitable form. In a preferred embodiment of the invention, however, the lithium bearing material may comprise a hard rock lithium mineral. The lithium bearing material may comprise an ore, a concentrate, a residue or waste product or the like, or any suitable combination thereof that comprises the hard rock lithium mineral. Preferably, however, at least a portion of the lithium in the lithium bearing material is present in the form of spodumene.

The spodumene present in the lithium bearing material may be in the form of alpha spodumene, beta spodumene or a combination thereof. It is envisaged that alpha spodumene is more likely to be present in naturally-occurring materials (such as lithium ores and mineral concentrates), while beta spodumene is more likely to be present in materials such as thermally processed concentrates and the like.

In some embodiments of the invention, the lithium bearing material may undergo one or more treatment steps prior to the first leaching step. Any suitable treatment steps may be performed, such as a size reduction step, a separation step, a classification step or the like. In a particular embodiment of the invention, the lithium bearing material may undergo a conversion step to convert at least a portion of the alpha spodumene present in the lithium bearing material to beta spodumene.

The conversion step may be of any suitable form, although in a preferred embodiment of the invention the conversion step may comprise a thermal processing step. Specifically, the lithium bearing material may be subject to a roasting process, calcining process or the like, at an elevated temperature to convert at least a portion of the alpha spodumene to beta spodumene. Any suitable elevated temperature may be used, although in a preferred embodiment, the elevated temperature may be between approximately 800° C. and 1200° C. More preferably, the elevated temperature may be between approximately 900° C. and 1100° C.

The thermal processing step may be performed for any suitable period of time, and it will be understood that the length of the thermal processing process may depend on a number of factors, such as the quantity of lithium minerals present in the lithium bearing material, the particle size of the lithium bearing material, the minerals present in the lithium bearing material and so on.

The thermal processing step may be performed as a batch process or as a continuous process. In a preferred embodiment of the invention the lithium bearing material may be cooled following the thermal processing step, and prior to further processing of the lithium bearing material.

In some embodiments of the invention, the lithium bearing material that has undergone the thermal processing step may be subject to one or more comminution processes and/or one or more classification process prior to the first leaching process. In a preferred embodiment of the invention, relatively fine particles of the lithium bearing material may be introduced to the first leaching process.

It is envisaged that a significant proportion of the alpha spodumene present in the lithium bearing material may be converted to beta spodumene in the thermal processing step. In some embodiments, at least 70% of the alpha spodumene present in the lithium bearing material may be converted to beta spodumene in the thermal processing step. More preferably, at least 80% of the alpha spodumene present in the lithium bearing material may be converted to beta spodumene in the thermal processing step. More preferably, at least 90% of the alpha spodumene present in the lithium bearing material may be converted to beta spodumene in the thermal processing step. In some embodiments of the invention, it is envisaged that between about 93% and about 96% of the alpha spodumene present in the lithium bearing material may be converted to beta spodumene in the thermal processing step. Thus, in this embodiment, a significant proportion of the lithium present in the lithium bearing material that is subjected to the first leaching process is in the form of beta spodumene.

As previously stated, the step of leaching of the lithium bearing material is performed at atmospheric pressure. It will be understood that the term “atmospheric pressure” refers to a pressure that is approximately equal to atmospheric pressure at sea level, or less than about 101.325 kPa. It will be understood, however, that relatively small variations to this pressure are intended to be encompassed within the meaning of the term “atmospheric pressure” that such the term atmospheric pressure may include leaching conducted under a slightly pressurised atmosphere, or under a slight vacuum. For instance, the vessel in which the leaching of the lithium bearing material is performed may be capable of operating at pressures above or below atmospheric pressure.

It will be understood, however, that the vessel may comprise a sealed vessel capable of pressures above or below atmospheric pressure. In some embodiments of the invention, the vessel may comprise a vacuum to manage vapour loss and/or air ingress.

The leaching process may be conducted in any suitable vessel. Preferably, however, the vessel comprises a tank, reactor, or the like. In a particular embodiment of the invention, the vessel may comprise a reactor, such as a tank or batch reactor. In some embodiments of the invention, the reactor may be agitated. In a specific embodiment, the reactor may be continuously stirred.

It is envisaged that the leaching process may be performed at an elevated temperature. It will be understood that the term “elevated temperature” refers to a temperature that is greater than ambient temperature. In a preferred embodiment, the leaching of the lithium bearing material is performed at a temperature of greater than 50° C. but less than 160° C. More preferably, the leaching of the lithium bearing material is performed at a temperature of greater than 50° C. but less than 140° C. More preferably, the leaching of the lithium bearing material is performed at a temperature of greater than 50° C. but less than 120° C. Most preferably, the leaching of the lithium bearing material is performed at a temperature of greater than 50° C. but less than 100° C.

Preferably, the temperature at which the leaching of the lithium bearing material is performed is configured to be between 50° C. and approximately the boiling point of the leaching solution.

It is envisaged that the lithium bearing material may be introduced to the leaching process in the form of solid material. As previously stated, the lithium bearing material is leached in the presence of carbonate ions. Preferably, the lixiviant comprises carbonate anions and alkali metal cations. Any suitable alkali metal cations may be present, although in a preferred embodiment of the invention, the alkali metal cations may comprise sodium ions. It will be understood that the lixiviant may comprise anions other than carbonate. For instance, the lixiviant may comprise bicarbonate ions.

The lixiviant may have any suitable concentration of carbonate ions. For instance, the concentration of carbonate ions in the lixiviant may be between about 17 g/L and 288 g/L. More preferably, the concentration of carbonate ion in the lixiviant may be between about 12 g/L and 230 g/L. Most preferably, the concentration of carbonate ions in the lixiviant may be between about 6 g/L and 173 g/L.

In a particular embodiment of the invention, the carbonate ions may be added as sodium carbonate. For instance, the concentration of sodium carbonate in the lixiviant may be between about 10 g/L and 500 g/L. More preferably, the concentration of sodium carbonate in the lixiviant may be between about 20 g/L and 400 g/L. More preferably, the concentration of sodium carbonate in the lixiviant may be between about 30 g/L and 300 g/L. Most preferably, the concentration of sodium carbonate in the lixiviant may be between about 30 g/L and 200 g/L

The lixiviant may have any suitable concentration of sodium ions. For instance, the concentration of sodium ions in the lixiviant may be between about 4 g/L and 217 g/L. More preferably, the concentration of sodium ion in the lixiviant may be between about 9 g/L and 174 g/L. Most preferably, the concentration of sodium ions in the lixiviant may be between about 13 g/L and 130 g/L.

In a particular embodiment of the invention, the carbonate ions may be added as potassium carbonate. For instance, the concentration of potassium carbonate in the lixiviant may be between about 10 g/L and 1000 g/L. More preferably, the concentration of potassium carbonate in the lixiviant may be between about 30 g/L and 600 g/L. Most preferably, the concentration of potassium carbonate in the lixiviant may be between about 50 g/L and 300 g/L.

In a particular embodiment of the invention, the leaching of lithium bearing material (in the form of beta spodumene) may proceed according to the following reaction:

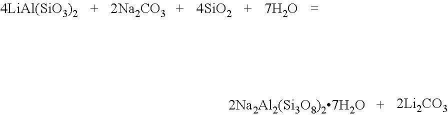

In this embodiment, it is envisaged that the leaching reaction may result in the extraction of lithium from the beta spodumene through the exchange of lithium and sodium ions. The sodium aluminium silicate present in the leaching solution may be in the form of a solid, while the lithium carbonate generated by the leaching reaction may be present in the form of a precipitated solid and/or in aqueous form in the leaching solution. In some embodiments, lithium carbonate may be present in the leaching slurry in both solid and aqueous forms.

In other embodiments, the leached solids may predominantly include sodium zeolite P2. Thus, in this embodiment of the invention, the conversion of beta spodumene to sodium zeolite P2 in the leaching of lithium bearing material may proceed according to the following reaction:

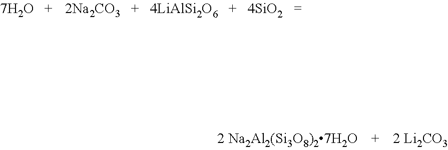

In general, lithium may initially leach from the solids and subsequently precipitate as lithium carbonate crystals once the solubility limit is reached under the leach conditions. At the conclusion of the first leaching process, the leaching solution may be essentially saturated with lithium.

The leaching process may be performed for any suitable period of time. Preferably, however, the residence time of the leaching process may be between about 1 hours and about 300 hours. More preferably, the residence time of the leaching process may be between about 2 hours and about 200 hours. More preferably, the residence time of the leaching process may be between about 3 hours and about 100 hours. It will be understood that the residence time may be dependent on a number of factors, such as the nature of the lithium bearing material, the temperature at which the leaching process is conducted, the concentration of carbonate ions in the lixiviant, the particle size of the lithium bearing material, the concentration of solids in solutions, and so on.

The first leaching process may be performed as a batch process or as a continuous process. Preferably, however, the leaching process may be a continuous process.

In some embodiments of the invention, the leaching slurry may be treated to recover heat at the conclusion of the first leaching process. Heat may be recovered using any suitable technique, although in a preferred embodiment, heat may be recovered using a heat exchange process. The heat exchange fluid used to recover heat from the leaching slurry may be of any suitable form. In some embodiments of the invention, the heat exchange fluid may be a process stream generated or used in another part of the method.

Before the second leaching process takes place, one or more process steps may be performed on the stream exiting the first leaching process.

In particular, it is envisaged that the stream exiting the first leaching process may comprise leached solids (including lithium carbonate) in a solution that is relatively high in potassium. Thus, in some embodiments, a solid-liquid separation process may be performed on the stream exiting the first leaching process.

Any suitable solid-liquid separation process may be used. For instance, the solid-liquid separation process may comprise a filtration process, an evaporation or drying process or the like. In other embodiments, a settling process or a counter current decantation process (such as one conducted in a thickener) may be performed to separate a clarified solution from the leached solids.

In some embodiments of the invention, the leached solids may, once separated from the clarified solution, be washed or otherwise cleaned in order to remove at least a portion of soluble species present thereon.

The leached solids may be treated in the presence of a carbonate solution. Any suitable treatment may be used, although in some embodiments the treatment may comprise repulping the leached solid with the carbonate solution. Any suitable carbonate solution may be used, such as lithium carbonate, potassium carbonate, or a combination of the two.

As previously stated, a carbon dioxide leaching process is performed on the solids of the leaching slurry to convert at least a portion of the lithium carbonate in the leaching slurry to lithium bicarbonate. The carbon dioxide leaching process may be performed using any suitable reactant, although in a preferred embodiment of the invention, the reactant may be a gas containing carbon. In a particular embodiment, the reactant may comprise carbon dioxide.

It is envisaged that the lithium carbonate converted to lithium bicarbonate may be the solid lithium carbonate in the leaching slurry. Preferably, lithium carbonate is converted to lithium bicarbonate according to the following reaction:

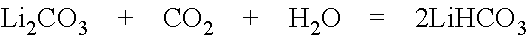

The carbon dioxide leaching process may be performed at any suitable temperature, and it is envisaged that the temperature may be chosen to enhance the solubility of the lithium bicarbonate. In a preferred embodiment of the invention, the carbon dioxide leaching process may be performed at a temperature of less than about 70° C. More preferably, the carbon dioxide leaching process may be performed at a temperature of no more than about 50° C. More preferably, the carbon dioxide leaching process may be performed at a temperature of no more than about 40° C. Most preferably, the carbon dioxide leaching process may be performed at a temperature of about 25° C.

The carbon dioxide leaching process may be performed at any suitable pressure, including at atmospheric pressure, or at greater than atmospheric pressure.

The carbon dioxide leaching process may be performed as a continuous process or as a batch process and may be performed in any suitable vessel, such as, but not limited to, autoclaves, adsorption towers, deep stirred tanks, atmospheric stirred tanks, or any suitable combination thereof. In a particular embodiment of the invention, the vessel comprises a deep atmospheric stirred tank.

Preferably, the carbon dioxide leaching process may solubilise at least 70% of the solid lithium carbonate in the leaching slurry. More preferably, the carbon dioxide leaching process may solubilise at least 80% of the solid lithium carbonate in the leaching solution. Even more preferably, the carbon dioxide leaching process may solubilise at least 90% of the solid lithium carbonate in the leaching solution. In some embodiments, the carbon dioxide leaching process may solubilise approximately 95% of the solid lithium carbonate in the leaching solution. It is envisaged that at least a portion of the lithium may be present as residual alpha spodumene from the carbonate leaching step, and therefore may not be available for carbonate dissolution.

Following the carbon dioxide leaching process, a solid-liquid separation process is performed on the leaching solution from the carbon dioxide leaching process to separate a leach residue from the leaching slurry. In this way, a concentrated lithium bearing leaching solution may be obtained. The concentrated lithium bearing solution may be collected for subsequent processing.

Any suitable solid-liquid separation process may be used. For instance, the solid-liquid separation process may comprise a filtration process, an evaporation or drying process or the like. In other embodiments, a settling or decantation process (such as a single-stage or multi-stage process conducted in a thickener) may be performed to separate a clarified leaching solution from the solid leaching residue.

In some embodiments of the invention, the leaching residue may, once separated from the leaching solution, be washed or otherwise cleaned to remove at least a portion of soluble species present thereon. The leaching residue may be washed or otherwise cleaned once, or may be washed or cleaned during two or more steps in the method.

It is envisaged that the leaching residue may form a tailings product from the extraction method. Beneficially, however, it is envisaged that the leaching residue may contain relatively high concentrations of zeolite. The zeolite may be used as an industrial raw material for a range of uses. As a result, tailings impoundment in the environment may not be necessary.

After the solid-liquid separation, the leaching solution is relatively free from solids and has a relatively high soluble lithium concentration. Lithium may then be precipitated from the leaching solution in the form of lithium carbonate by altering the solution chemistry.

Any suitable precipitation reaction may be used to precipitate lithium, depending on the specific process requirements. For example, additional heat can be applied to accelerate the reaction. However, at higher temperatures, carbon dioxide may be released from the leaching solution, which leads to the formation of carbonate ions. The presence of carbonate ions favours the precipitation of lithium carbonate, as lithium carbonate is significantly less soluble in the presence of carbonate ions compared to bicarbonate ions. As a result, lithium carbonate precipitates out of the solution. In this embodiment, the lithium carbonate precipitation proceeds according to the following reaction:

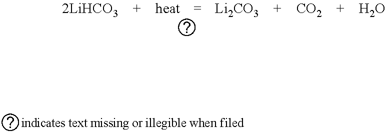

This reaction represents the thermal decomposition of lithium bicarbonate into lithium carbonate, carbon dioxide, and water. The controlled addition of heat ensures the efficient removal of lithium from the leaching solution in the form of lithium carbonate.

The precipitation of lithium carbonate may be performed in any suitable vessel, such as, but not limited to, a stirred tank reactor or a crystallizer with temperature control.

In a preferred embodiment of the invention, the precipitation of lithium carbonate may be conducted at an elevated temperature. Preferably, the precipitation of lithium carbonate may be performed at a temperature of between about 30° C. and 99° C. More preferably, the precipitation of lithium carbonate may be performed at a temperature of between about 50° C. and 90° C.

In some embodiments, the temperature of the leaching solution may be elevated using a heat source, such as a burner, steam injection, heater or the like. In an alternative embodiment, the temperature of the leaching solution may be elevated using a heat exchange process. The heat exchange fluid may be of any suitable type, although in a preferred embodiment of the invention, the heat exchange fluid may comprise the leaching solution leaving the first or second leaching process. In this way, the leaching solution leaving the first or second leaching process may be cooled and the leaching solution undergoing lithium carbonate precipitation may be heated, thereby reducing or eliminating the need for an external heat source.

Precipitated lithium carbonate may be separated from the leaching solution using any suitable technique. For instance, the precipitated lithium carbonate may be separated using a filtration process, an evaporation or drying process or the like. In other embodiments, a settling or thickening process may be performed to separate a clarified leaching solution from the precipitated lithium carbonate.

Preferably, the precipitated lithium carbonate is separated using filtration to provide a filter cake. In some embodiments of the invention, the filtered, precipitated lithium carbonate may be washed with water to provide a moist lithium carbonate filter cake.

Preferably, the filtrate solution from the separation process may be recycled as carbonate leaching solution. The carbonate leaching solution may contain soluble lithium carbonate and trace quantities of sodium carbonate, which may be beneficially recycled to the leaching process.

In a seventh aspect, the invention resides broadly in a method for the extraction of lithium, the method comprising the steps of:
Subjecting a lithium bearing material containing beta spodumene to a leaching process at atmospheric pressure in the presence of carbonate ions to produce a first leaching slurry including lithium carbonate;
Performing a solid-liquid separation process on the first leaching slurry to separate a first leach residue from a first leaching solution;
Performing a repulping process on the first leach residue in the presence of a carbonate ions to produce a second leaching slurry;
Performing a carbon dioxide leaching process on the second leaching slurry to produce a bicarbonate leaching slurry in which at least a portion of the lithium carbonate is converted to lithium bicarbonate;
Performing a solid-liquid separation process on the bicarbonate leaching slurry to separate a second leach residue from a second leaching solution;
Precipitating lithium carbonate from the second leaching solution; and
Separating precipitated lithium carbonate from the second leaching solution.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 illustrates a method for the extraction of lithium according to a first embodiment of the present invention.

FIG. 2 illustrates a method for the extraction of lithium according to a second embodiment of the present invention.

FIG. 3 illustrates a method for the extraction of lithium according to a third embodiment of the present invention.

FIG. 4 illustrates a method for the extraction of lithium according to a fourth embodiment of the present invention.

FIG. 5 illustrates a method for the extraction of lithium according to a fifth embodiment of the present invention.

FIG. 6 illustrates a method for the extraction of lithium according to a fourth embodiment of the present invention.

FIG. 7 illustrates a method for the extraction of lithium according to a sixth embodiment of the present invention

### DETAILED DESCRIPTION

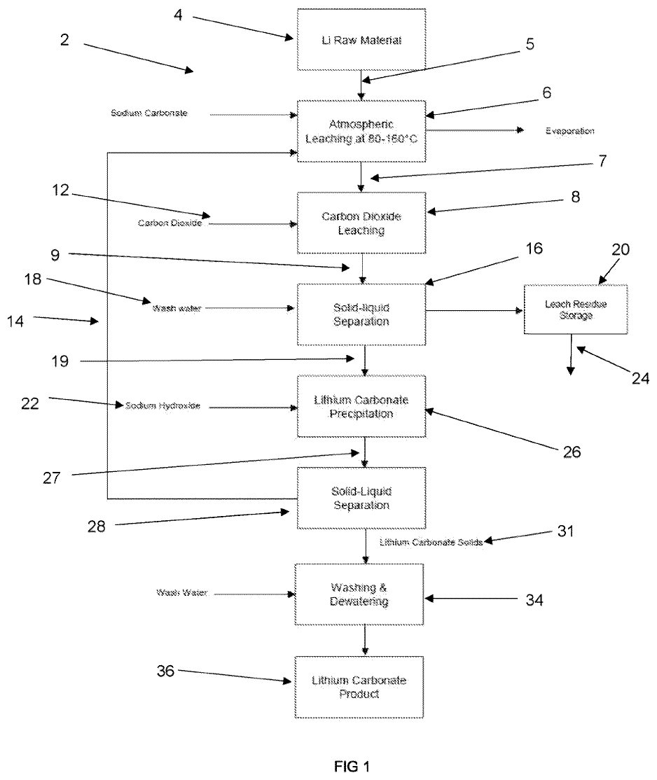

FIG. 1 illustrates a method 2 for the extraction of lithium according to an embodiment of the present invention. In the method 2, a lithium raw material 4 is converted into a lithium bearing material 5. The conversion of the lithium raw material 4 into the lithium bearing material 5 is conventional and no further discussion of this is required. The lithium bearing material 5 is a solid material.

The lithium bearing material 5 is subjected to a leaching process 6 which is performed at atmospheric pressure in the presence of sodium carbonate. In the embodiment of the invention illustrated in FIG. 1, the lithium bearing material 5 is introduced to a lixiviant containing an aqueous solution of sodium carbonate. In general terms, the concentration of sodium carbonate in the lixiviant is between 30 g/L and 300 g/L, and it will be understood that the concentration of sodium carbonate in the lixiviant will be at least partially determined by the concentration of lithium in the lithium bearing material 5.

The leaching process 6 is performed in a continuously stirred tank reactor at 101.325 kPa, and at a temperature of greater than 80° C. but less than 160° C. The temperature of the leaching process 6 is configured to be below, but relatively close to, the boiling point of the lixiviant.

The residence time and size of the leaching vessel of the lithium bearing material 5 in the leaching process 6 will be dependent on a number of factors, including the quantity of lithium in the lithium bearing material 5, the concentration of sodium carbonate in the lixiviant, the pressure and temperature at which the leaching process 6 is conducted, and so on. However, it will be understood that the residence time of the lithium bearing material 5 in the leaching process 6 will be determined at least partly by the time taken to extract substantially all, or at least a significant portion of, the lithium from the lithium bearing material 5.

The leaching slurry 7 is treated to recover heat from the leaching slurry 7 at the conclusion of the leaching process 6. To do so, the leaching solution 7 is subjected to a heat exchange process using a stream generated in another part of the method 2, such as a sodium carbonate recycle stream 14 to the leaching process 6.

In another embodiment of the invention shown, leaching slurry 7 is treated to recover heat from the leaching slurry 7 at the conclusion of the leaching process 6. To do so, the leaching slurry 7 is subjected to a heat exchange process using a stream generated in another part of the method 2, such as the bicarbonate solution containing dissolved lithium stream 19 to the leaching process 6.

At the conclusion of the leaching process 6, a leaching slurry 7 containing lithium carbonate (in both aqueous and solid form) and one or more zeolites (sodium aluminium silicate) in solid form is introduced to a carbonation process 8. The purpose of the carbonation process 8 is to convert lithium carbonate in the leaching slurry 7 to soluble lithium bicarbonate by reacting lithium carbonate with carbon dioxide 12.

The lithium carbonate converted to lithium bicarbonate may be the solid lithium carbonate in the leaching slurry 7, the aqueous lithium carbonate, or a combination of the two.

The carbonation process 8 in the embodiment depicted in FIG. 1 is performed at a temperature of no more than about 50° C., and at substantially atmospheric pressure.

Leaching solution 9 exiting the carbonisation process 8 is in the form of an aqueous solution of lithium bicarbonate and solid leaching residue 20. The leaching solution 9 is then subjected to a solid-liquid separation process 16 to separate a solid leach residue 20 from the leaching solution 9 in order to produce a leaching solution 19 having a high lithium concentration.

The solid-liquid separation process 16 comprises a filtration process performed to separate a clarified leaching solution 19 from the solid leaching residue 20.

In the embodiment of the invention illustrated in FIG. 1, the solid leach residue 20, once separated from the leaching solution 9, is washed 18 in order to remove at least a portion of soluble species present thereon.

The solid leach residue 20 forms a tailings product from the extraction method 2. The leaching residue 20 contains relatively high concentrations of zeolites 24.

Following the solid-liquid separation process 16, the leaching solution 19 is relatively free from solids and has a relatively high lithium concentration. The leaching solution 19 may therefore undergo a precipitation step 26 in the presence of sodium hydroxide 22 to precipitate lithium from the leaching solution 19 in the form of relatively insoluble lithium carbonate. In FIG. 1 the precipitation step 26 is performed at a temperature of about 50° C.

Following the precipitation step 26, the leaching solution 27 comprises solid lithium carbonate in an aqueous solution of sodium carbonate. A further solid-liquid separation step 28 is performed on the leaching solution 27 to produce solid lithium carbonate 31 and carbonate recycle stream 14 which is recycled to the leaching process 6 for use as the lixiviant.

In FIG. 1 the temperature of the recycle stream 14 returned to the leaching process 6 is relatively low, allowing the recycle stream 14 to be used in a heat exchange process. Specifically, heat from the relatively hot leaching solution 7 leaving the leaching process 6 exchanged with the recycled stream 19. In this way, the leaching solution 7 leaving the leaching process 6 may be cooled and stream 19 may be heated, thereby reducing or eliminating the need for an external heat source.

In FIG. 1, the precipitated lithium carbonate 31 is washed and dewatered 34 to produce a relatively pure lithium carbonate product 36.

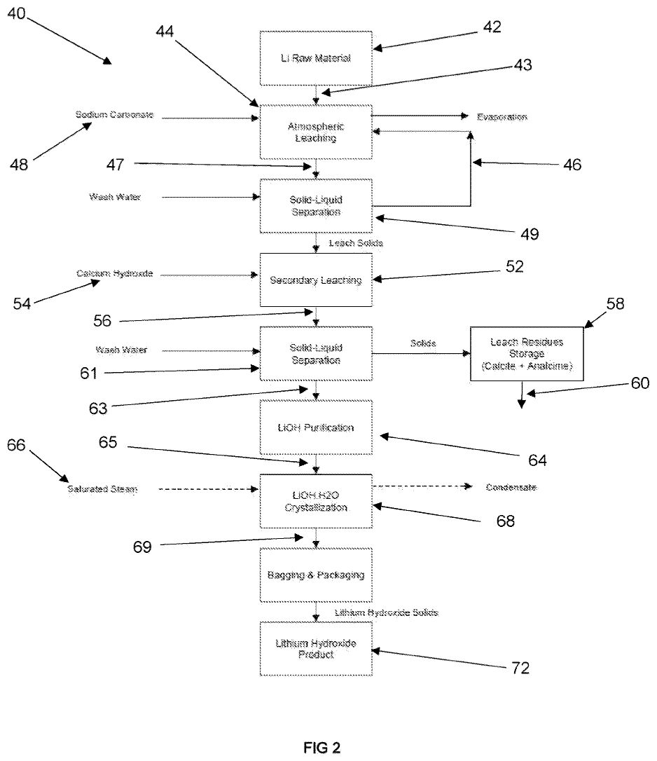

FIG. 2 illustrates a method 40 for the extraction of lithium according to an embodiment of the present invention.

Specifically, FIG. 2 relates to a method similar to FIG. 1 in the use of a raw lithium starting material 42 and an atmospheric leaching process 44, but the final product is a lithium hydroxide product 72.

FIG. 2 illustrates a method 40 for the extraction of lithium according to an embodiment of the present invention. In the method, a lithium raw material 42 comprises a solid and liquid suspension 43. The conversion of the lithium raw material 42 into the solid and liquid suspension lithium bearing material 43 is conventional and no further discussion of this is required.

The lithium bearing material 43 is subjected to a leaching process 44 which is performed at atmospheric pressure in the presence of sodium carbonate 48. In the embodiment of the invention illustrated in FIG. 2, the lithium bearing material 43 is introduced to a lixiviant containing an aqueous solution of sodium carbonate 48. In general terms, the concentration of sodium carbonate 48 in the lixiviant is between 30 g/L and 300 g/L, and it will be understood that the concentration of sodium carbonate 48 in the lixiviant will be at least partially determined by the concentration of lithium in the lithium bearing material 42.

The leaching process 44 is performed in a continuously stirred tank reactor at 101.325 kPa, and at a temperature of greater than 80° C. but less than 160° C. The temperature of the leaching process 44 is configured to be below, but relatively close to, the boiling point of the lixiviant.

The residence time of the lithium bearing material 43 in the leaching process 44 will be dependent on a number of factors, including the quantity of lithium in the lithium bearing material 42, the concentration of sodium carbonate in the lixiviant, the pressure and temperature at which the leaching process 44 is conducted, the size of the leaching vessel and so on However, it will be understood that the residence time of the lithium bearing material 43 in the leaching process 44 will be determined at least partly by the time taken to extract substantially all, or at least a significant portion of, the lithium from the lithium bearing material 43.

However, unlike in FIG. 1, the leaching solution 47 is subjected to a solid-liquid separation process 49 (in the form of a filtration process, counter current decantation process, such as using a thickener or the like) to separate solid leach residue (containing lithium carbonate) from the leaching solution 47. The separated liquid 46 (which is relatively high in sodium carbonate) is returned to the leaching process 44 as the lixiviant.

The solid leach residue is subjected to a second leaching process 52 in the presence of hydroxide ions (and, in the embodiment illustrated in FIG. 2, calcium hydroxide ions 54) to generate leaching solution 56 containing an aqueous solution of lithium hydroxide.

The leaching solution 56 also comprises solid leach residue including calcium carbonate and sodium compounds. Thus, the leaching solution 56 is subject to a further solid-liquid separation process 61 (in the form of a filtration process) to separate the solid leach residue 58 from the leaching solution 56 to produce a lithium leaching solution that is relatively free of solids 63.

In the embodiment of the invention shown in FIG. 2, the solid leach residue 58 forms a byproduct of the extraction method 40. Specifically, the solid leach residue 58 is at least partially comprising calcite and zeolites 60.

Prior to the production of a solid lithium hydroxide product 72, the lithium hydroxide solution 63 undergoes a purification step 64 in the form of a partial evaporation to crystallise relatively high purity lithium hydroxide monohydrate 68. In addition, the lithium hydroxide solution stream 65 is subjected to a crystallisation process 68 in the form of sublimation or precipitation 66 to produce lithium hydroxide crystals 69 that form the solid lithium hydroxide product 72.

In another embodiment of the invention, the lithium hydroxide solution 63 undergoes a purification step 64 in the form of a partial evaporation to crystallise relatively high purity lithium hydroxide monohydrate 68. The purification step 64 may include an ion exchange process to remove di- and tri-valent cations before subjecting the lithium hydroxide solution stream 65 to a crystallisation process 68.

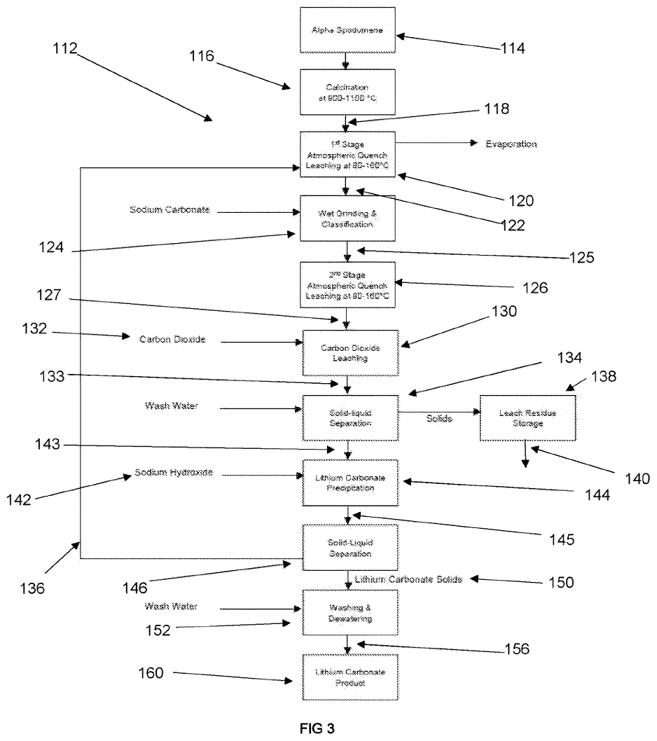

FIG. 3 illustrates a method 112 for the extraction of lithium according to an embodiment of the present invention.

Specifically, the lithium bearing solids 114 in FIG. 3 is an alpha spodumene material 114 (such as an ore). Prior to leaching 116, the alpha spodumene material 114 is converted to a beta spodumene material 120 by roasting or calcining 116 the alpha spodumene material 114 at a temperature of between 900° C. and 1100° C. until such time as substantially all of the alpha spodumene 114 has been converted to beta spodumene 118.

The hot beta spodumene 118 may then be subjected to the leaching process 120 to produce partially leached and ground solids containing lithium carbonate 122 in the same manner as described with reference to FIG. 1.

The partially leached solids containing lithium carbonate 122 are subjected to a classification and grinding process 124. In the specific embodiment 112 the grinding process is a wet grinding process, specifically a ball milling process.

The partially leached and ground solids in carbonate solution 125 are subjected to a secondary leaching process 126 to produce leached solids containing lithium carbonate 122 in the same manner as described with reference to FIG. 1.

At the conclusion of the leaching process 126, a leaching solution 127 containing lithium carbonate (in both aqueous and solid form) and zeolites (sodium aluminium silicate) is introduced to a carbonation process 130. The purpose of the carbonation process 130 is to convert lithium carbonate in the leaching solution 127 to soluble lithium bicarbonate by reacting lithium carbonate with carbon dioxide 132.

The bicarbonate solution containing dissolved lithium 133 then undergoes a solid-liquid separation 134 to yield a leach residue solid 138 containing zeolites 140, and a bicarbonate solution containing dissolved lithium 143 that is undergoes a precipitation process 144 in the presence of sodium hydroxide 142 in the same manner as described with reference to FIG. 1.

The lithium carbonate solids suspended in the leach solution 145 are subjected to a solid-liquid separation process 146 (in the form of a filtration process) to separate solid leach residue (containing lithium carbonate 150) from the leaching solution 146. The separated liquid 136 (which is relatively high in sodium carbonate) is returned to the leaching process 120 as the lixiviant.

The lithium carbonate solids 150 collected from the separation process 146 undergo washing and dewatering 152 to produce relatively pure lithium carbonate solids 156 ready for use as lithium carbonate product 160.

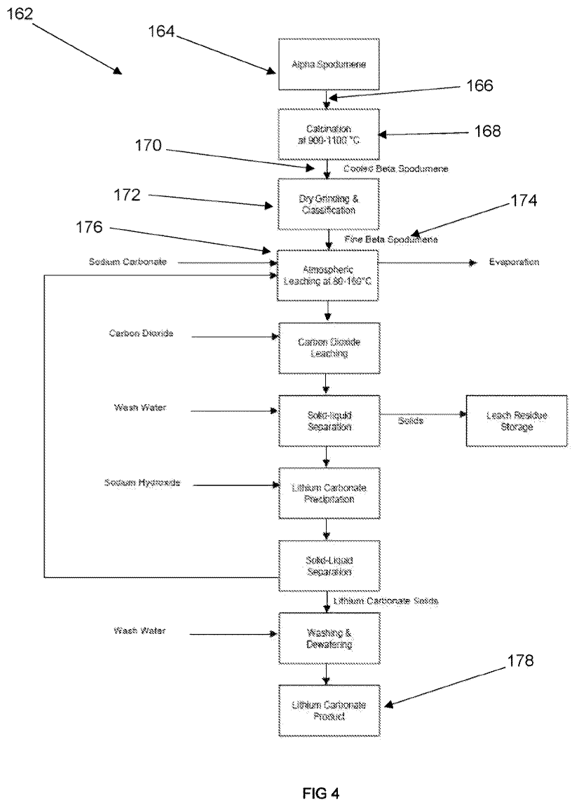

FIG. 4 illustrates a method 162 for the extraction of lithium according to an embodiment of the present invention.

Specifically, FIG. 4 relates to a method similar to FIG. 3 in the use of alpha spodumene starting material 164 and a conversion process 168 but the method presented in FIG. 4 proceeds with cooled beta spodumene 170.

Specifically, the lithium raw material 166 in FIG. 4 is an alpha spodumene material 164 (such as an ore). Prior to leaching 176, the alpha spodumene material 164 is converted to a beta spodumene material 170 by roasting or calcining 168 the alpha spodumene material 166 at a temperature of between 900° C. and 1100° C. until such time as substantially all of the alpha spodumene 164 has been converted to beta spodumene 170.

The beta spodumene material 170 that exits the roaster or calciner 168 is cooled prior to undergoing a comminution (grinding) and classification (screening) process 172 to separate relatively fine beta spodumene particles 174 from relatively coarse beta spodumene particles. Relatively coarse beta spodumene particles may be recycled to the comminution and classification process 172 to generate relatively fine beta spodumene particles 174 or may be discarded depending on the type of material.

The fine beta spodumene particles 174 may then be subjected to the leaching process 176 to ultimately produce relatively high purity lithium carbonate 178 in the same manner as described with reference to FIG. 1.

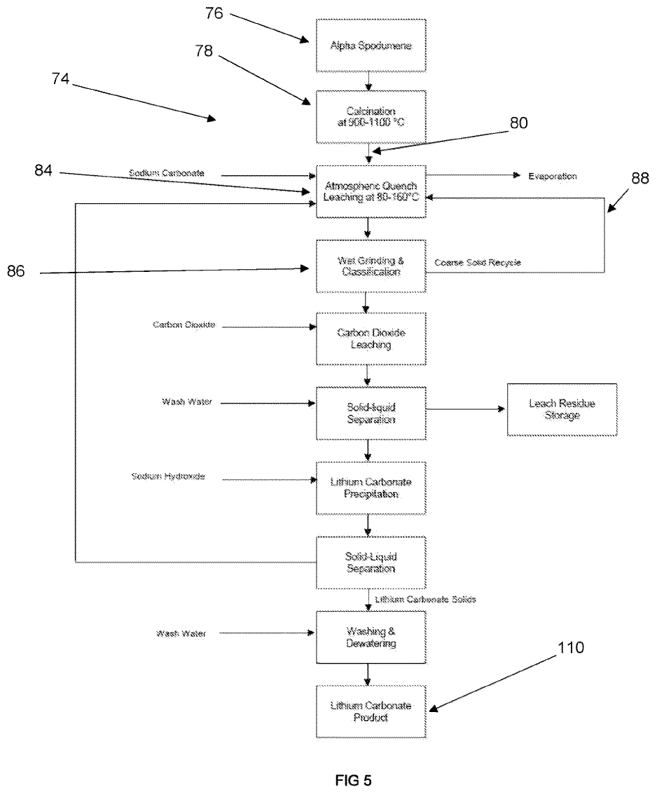

FIG. 5 illustrates a method 74 for the extraction of lithium according to an embodiment of the present invention.

Specifically, FIG. 5 relates to a method similar to FIG. 3 in the use of alpha spodumene starting material 76 but in this embodiment the hot beta spodumene 80 is immediately subjected to an atmospheric leaching process 84.

The alpha spodumene 76 starting material is converted 78 to hot beta spodumene 80 in the same manner as described with reference to FIG. 3.

To utilise available heat energy, the hot beta spodumene 80 is then subjected to the leaching process 84 where it may then undergo an optional wet grinding and classification process 86 before continuing to ultimately produce relatively high purity lithium carbonate 110 in the same manner as described with reference to FIG. 1.

When the optional wet grinding and classification process 86 is included, the coarse solids separated from the classification process 86 may be recycled 88 back to the atmospheric leaching process 84 for reprocessing.

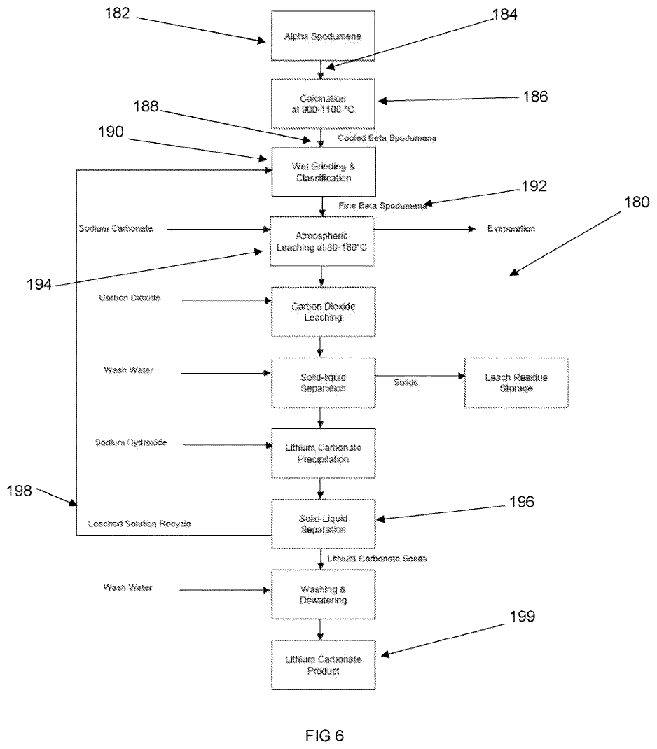

FIG. 6 illustrates a method 180 for the extraction of lithium according to an embodiment of the present invention.

Specifically, FIG. 6 relates to a method similar to FIG. 4 in the use of alpha spodumene starting material 182 but in this embodiment the cooled beta spodumene 188 is immediately subjected to a wet grinding and classification process 190 prior to the atmospheric leaching process 194.

The lithium bearing solids 184 undergo a calcination process 186 in the same manner as previously described in FIG. 4 to produce cooled beta spodumene 188.

The beta spodumene material 188 that exits the roaster or calciner 186 is cooled prior to undergoing a comminution (grinding) and classification (screening) process 190 to separate relatively fine beta spodumene particles 192 from relatively coarse beta spodumene particles. Relatively coarse beta spodumene particles may be recycled to the comminution and classification process 190 to generate relatively fine beta spodumene particles 192 or may be discarded depending on the type of material.

The fine beta spodumene particles 192 may then be subjected to the leaching process 194 to ultimately produce relatively high purity lithium carbonate 199 in the same manner as described with reference to FIG. 1.

In the embodiment of the invention described in FIG. 6, the solid-liquid separation process 196 may recycle the carbonate leach solution 198 back to the wet grinding and classification process 190.

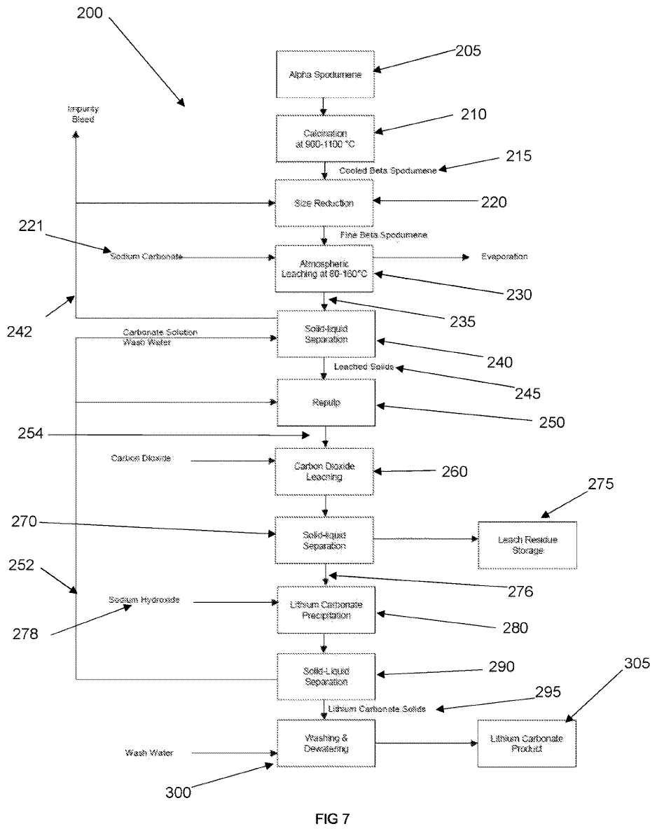

FIG. 7 illustrates a method 200 for the extraction of lithium according to an embodiment of the present invention. In the method, a lithium bearing material 205 containing alpha spodumene is feed into a spodumene conversion process 210 to convert at least a portion of the alpha spodumene presented in the lithium bearing material 205 into beta spodumene 215.

The conversion of a portion of the alpha spodumene present in the lithium bearing material 205 to beta spodumene 215 comprises a calcining processing step at an elevated temperature between approximately 900° C. and 1100° C.

The lithium bearing material containing beta spodumene 215 is cooled and then undergoes a size reduction step 220 to reduce the particle size of the lithium bearing material 215.

After the size reduction step 220, the lithium bearing material 215 is subjected to a leaching process 230 which is performed at atmospheric pressure in the presence of a sodium carbonate solution, preferably, an aqueous solution of sodium carbonate 221. This leaching process 230 may be performed at a temperature of between approximately 80° C. and 160° C., although in the embodiment of the invention illustrated in FIG. 7 the temperature at which the leaching process 230 is performed may be no more than 100° C., so as to avoid the use of autoclaves.

A leaching reaction occurs during the leaching process 230, resulting in the extraction of lithium from the beta spodumene through the exchange of lithium and sodium ions. The lithium carbonate generated in the leaching process 230 is present in the form of a precipitated solid and/or in aqueous form in a leaching slurry 235.

The leaching slurry 235 is subsequently introduced to a solid-liquid separation process 240 to separate a clarified leaching solution 242 from the leached solids 245. At least a portion of the clarified leaching solution 242 is recycled to the size reduction step 220 to be used again in the leaching process 230.

The leached solids 245, once separated from the clarified leaching solution 242, may be washed or otherwise cleaned in order to remove at least a portion of soluble species present thereon.

The leached solids 245 are introduced to a repulping process 250 in the presence of a recycled sodium carbonate solution 252. The repulping process 250 is performed at a temperature of about 90° C. The temperature of the repulped slurry 254 will be cooled to a temperature of less than 40° C. prior to advancing to the carbon dioxide leaching process 260.

Next, a carbon dioxide leaching process 260 is performed on the slurry 254 from the repulping process 250 to convert at least a portion of the lithium carbonate in the slurry 254 to lithium bicarbonate. The carbon dioxide leaching process 260 may be performed at atmospheric pressure in continuously stirred tank reactors or autoclaves.

Following the carbon dioxide leaching process 260, a solid-liquid separation process 270 is performed on the slurry from the carbon dioxide leaching process 260 to separate a leach residue 275 from the leaching slurry. The leaching residue 275, once separated from the leaching slurry, is washed or otherwise cleaned in order to remove at least a portion of soluble species present thereon.

The leaching residue 275, contains relatively high concentrations of zeolites.

After the solid-liquid separation process 270, the leaching solution 276 is relatively free from solids and has a relatively high soluble lithium concentration. Lithium is then precipitated from the leaching solution 276 in the form of lithium carbonate by introducing sodium hydroxide 278 to a precipitation process 280.

Additional heat is applied to facilitate the reaction of the precipitation process 280. The controlled addition of heat ensures the efficient removal of lithium from the leaching solution in the form of lithium carbonate.

This reaction can produce a minor quantity of soluble sodium carbonate as a byproduct. However, the sodium carbonate can be recycled back into the repulping process 250 as a lixiviant, enhancing the overall efficiency and sustainability of the process by minimising waste.

During the subsequent solid-liquid separation process 290, the precipitated lithium carbonate 295 is separated from the carbonate leaching solution 252 via thickening and/or filtration. The lithium carbonate 295 is washed 300 with water and filtered to produce a moist lithium carbonate filter cake 305.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1-98. (canceled)

99. A method when used for the extraction of lithium from a hard rock lithium mineral, the method comprising:
subjecting the lithium bearing material to a leaching process at atmospheric pressure, and at a temperature of greater than 50° C. but less than 160° C., in the presence of carbonate ions to produce a leaching slurry containing lithium carbonate.

100. The method of claim 99, wherein the hard rock lithium minerals comprises spodumene, lepidolite, eucryptite, petalite, a silicate material containing lithium, or a combination thereof.

101. The method according to claim 99, wherein the lithium bearing material undergoes one or more treatment steps prior to the leaching step.

102. A method for the extraction of lithium, the method comprising:
subjecting a lithium bearing material to a leaching process at atmospheric pressure and at an elevated temperature of greater than 50° C. but less than 160° C. in the presence of carbonate ions to produce a leaching slurry containing lithium carbonate;
performing a carbonation process on the leaching slurry to convert at least a portion of the lithium carbonate to lithium bicarbonate;
performing a solid-liquid separation process on the leaching slurry to separate a leach residue from a leaching solution;
obtaining solid lithium carbonate from the leaching solution; and
separating the solid lithium carbonate from the leaching solution.

103. The method of claim 102, wherein the lithium bearing material comprises a hard rock lithium material.

104. The method of claim 102, wherein at least a portion of the lithium in the lithium bearing material is present in the form of spodumene.

105. The method of claim 102, wherein the lithium bearing material undergoes a conversion step to convert at least a portion of alpha spodumene present in the lithium bearing material to beta spodumene.

106. The method of claim 105, wherein the conversion step is a thermal processing step comprising a roasting process or a calcining process, performed at an elevated temperature to convert at least a portion of the alpha spodumene to beta spodumene.

107. The method of claim 106, wherein the lithium bearing material that has undergone the thermal processing step is subject to one or more comminution processes and/or one or more classification processers prior to the leaching process.

108. The method of claim 102, wherein the elevated temperature of the leaching process is at least partially controlled via an exchange of heat between a relatively cool leach solution recycled from another point in the method and a relatively hot leach slurry leaving the leaching process.

109. The method of claim 102, wherein, in the leaching process, the lithium bearing material is introduced to a lixiviant containing the carbonate ions.

110. The method of claim 109, wherein the lixiviant comprises alkali metal cations.

111. The method of claim 102, wherein leaching of the lithium bearing material proceeds according to the following reaction:

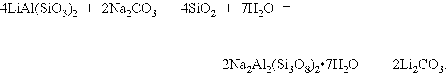

112. The method of claim 102, wherein the leaching slurry is treated to recover heat at the conclusion of the leaching process.

113. The method claim 102, wherein the lithium carbonate is converted to the lithium bicarbonate according to the following reaction:

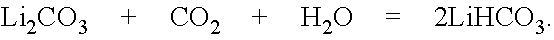

114. The method of claim 102, wherein the carbonation process is performed at a temperature of no more than about 70° C.

115. The method of claim 102, wherein the solid-liquid separation process comprises a filtration process, an evaporation process, a drying process, a settling process or a counter current decantation process.

116. The method of claim 102, wherein the solid lithium carbonate is obtained via a precipitation reaction.

117. A method for the extraction of lithium, the method comprising:
subjecting a lithium bearing material to a first leaching process at atmospheric pressure in the presence of carbonate ions to produce lithium carbonate;
subjecting the lithium carbonate to a second leaching process in the presence of hydroxide ions to produce a leaching slurry containing an aqueous solution of lithium hydroxide;
separating a solid leach residue from the leaching slurry to produce a lithium hydroxide solution that is relatively free of solids; and
producing a solid lithium hydroxide product from the lithium hydroxide solution that is relatively free of solids.

118. A method for the extraction of lithium, the method comprising:
subjecting an alpha spodumene containing material to a conversion process at atmospheric pressure to convert at least a portion of the alpha spodumene to beta spodumene;
subjecting the beta spodumene to a leaching process at atmospheric pressure in the presence of carbonate ions to produce a leaching solution and leached solids containing lithium carbonate;
subjecting the leached solids containing lithium carbonate to a size reduction and/or classification process in a solution containing the carbonate ions to generate a leaching slurry containing relatively fine solids;
performing a carbonation process on the leaching slurry to convert at least a portion of the lithium carbonate to lithium bicarbonate;
performing a solid-liquid separation process on the leaching slurry to separate a leach residue from a leaching solution;
obtaining solid lithium carbonate from the leaching solution; and
separating the solid lithium carbonate from the leaching solution.

119. A method for the extraction of lithium, the method comprising:
subjecting an alpha spodumene containing material to a conversion process at atmospheric pressure to convert at least a portion of the alpha spodumene to beta spodumene;
subjecting the beta spodumene to a grinding process to produce ground beta spodumene;
subjecting the ground beta spodumene to a leaching process at atmospheric pressure in the presence of carbonate ions to produce a leaching slurry containing lithium carbonate and leached solids;
performing a carbonation process on the leaching slurry to convert at least a portion of the lithium carbonate to lithium bicarbonate;
performing a solid-liquid separation process on the leaching slurry to separate a leach residue from a leaching solution;
obtaining solid lithium carbonate from the leaching solution; and
separating the solid lithium carbonate from the leaching solution.

120. A method for the extraction of lithium, the method comprising:
subjecting a lithium bearing material containing beta spodumene to a leaching process at atmospheric pressure in the presence of carbonate ions to produce a leaching slurry including lithium carbonate;
performing a carbon dioxide leaching process on the leaching slurry to produce a bicarbonate leaching slurry in which at least a portion of the lithium carbonate is converted to lithium bicarbonate;
performing a solid-liquid separation process on the bicarbonate leaching slurry to separate a leach residue from a leaching solution;
precipitating lithium carbonate from the leaching solution; and
separating precipitated lithium carbonate from the leaching solution.

121. A method for the extraction of lithium, the method comprising:
subjecting a lithium bearing material containing beta spodumene to a leaching process at atmospheric pressure in the presence of carbonate ions to produce a first leaching slurry including lithium carbonate;
performing a solid-liquid separation process on the first leaching slurry to separate a first leach residue from a first leaching solution;
performing a repulping process on the first leach residue in the presence of a carbonate ions to produce a second leaching slurry;
performing a carbon dioxide leaching process on the second leaching slurry to produce a bicarbonate leaching slurry in which at least a portion of the lithium carbonate is converted to lithium bicarbonate;
performing a solid-liquid separation process on the bicarbonate leaching slurry to separate a second leach residue from a second leaching solution;
precipitating lithium carbonate from the second leaching solution; and
separating precipitated lithium carbonate from the second leaching solution.
